(19) United States
(12) Patent Application Publication
(10) Pub. No.: US 2015/0350684 A1
(43) Pub. Date: Dec. 3, 2015

(54) IMAGE PROCESSING APPARATUS AND METHOD

(71) Applicant: SONY CORPORATION, Tokyo (JP)

(72) Inventors: Yoshitomo Takahashi, Kanagawa (JP); Ohji Nakagami, Tokyo (JP)

(73) Assignee: Sony Corporation, Tokyo (JP)

(21) Appl. No.: 14/427,768

(22) PCT Filed: Sep. 11, 2013
(86) PCT No.: PCT/JP2013/074465

§ 371 Date: Mar. 12, 2015

(30) Foreign Application Priority Data
Sep. 20, 2012 (JP) 2012-206837

(51) Int. Cl. H04N 19/70; H04N 19/176; H04N 19/174; H04N 19/117; H04N 19/124; H04N 19/146; H04N 19/597; H04N 19/103

(52) U.S. Cl. CPC H04N 19/70; H04N 19/597; H04N 19/176; H04N 19/103; H04N 19/117; H04N 19/124; H04N 19/146; H04N 19/174

(57) ABSTRACT

The present disclosure relates to an image processing apparatus and method that enables a reduction in the amount of encoding of a slice header of a non-base view.

In the slice header, a dependent slice is shared below a Dependent slice flag and above an Entry point if the Dependent slice flag is 1. In a shared part of the dependent slice, values for an inter-view prediction image within a Long-term index, Reference picture modification, and Weighted prediction are collectively placed in a different area from the slice header. The present disclosure can be applied to, for example, an image processing apparatus.

### TECHNICAL FIELD

The present disclosure relates to an image processing apparatus and method, and particularly relates to an image processing apparatus and method that makes it possible to reduce the amount of encoding of a slice header of a non-base view.

### BACKGROUND ART

In recent years, an apparatus has been becoming widespread which handles image information as digital information, adopts, for the purpose of transmitting and storing information with high efficiency at the time of handling the image information, an encoding format that uses redundancy unique to the image information to perform compression by an orthogonal transformation, such as a discrete cosine transform, and motion compensation, and compresses and encodes the image. Examples of the encoding format include MPEG (Moving Picture Experts Group), and H.264 and MPEG-4 Part 10 (Advanced Video Coding, hereinafter written as H.264/AVC).

The standardization of an encoding format called HEVC (High Efficiency Video Coding) by the JCTVC (Joint Collaboration Team-Video Coding) being a joint standardization group from ITU-T and ISO/IEC is currently under way to further improve coding efficiency, as compared to H.264/AVC (see, for example, Non-Patent Document 1).

A dependent slice (Dependent slice) is adopted as one of parallel processing tools in the current draft of HEVC. The use of the dependent slice makes it possible to copy a major part of a slice header of an immediately previous slice. Consequently, the amount of encoding of the slice header can be reduced.

For example, Non-Patent Document 2 proposes a Header parameter Set (HPS) that sets a flag and shares parameters between parameter sets, slice headers, or the like, for the purpose of reducing the amount of encoding of the slice header.

### CITATION LIST

### Patent Document

Non-Patent Document 1: Benjamin Bross, Woo-Jin Han, Jens-Rainer Ohm, Gary J. Sullivan, Thomas Wiegand, “High efficiency video coding (HEVC) text specification draft 8”, JCTVC-J1003_d7, 2012.7.28
Non-Patent Document 2: Ying Chen, Ye-Kui Wang (Qualcomm Inc.), Miska M. hannuksela (Nokia Corporation), “Header parameter set (HPS)”, JCTVC-I0109, Joint Collaborative Team on Video Coding (JCT-VC) of ITU-T SG16 WP3 and ISO/IEC JTC1/SC29/WG11 10th Meeting: Stockholm, SE, 11-20 Jul. 2012

### SUMMARY OF THE INVENTION

### Problems to be Solved by the Invention

When multiview coding is considered, it is assumed that a major part of the syntax of a slice header is common between views. Applying a dependent slice between views is conceivable. However, syntaxes that are difficult to share between views are included in the slice header.

There is no description of the application of the dependent slice between views in Non-Patent Document 2.

The present disclosure has been made considering such circumstances, and can reduce the amount of encoding of the slice header of a non-base view.

### Solutions to Problems

A first aspect of an image processing apparatus of the present disclosure includes a decoding unit that uses inter-view prediction parameters used for inter-view prediction, and performs a decoding process on an encoded stream encoded in units having a hierarchy structure in the syntax of the encoded stream where the inter-view prediction parameters are collectively placed.

The inter-view prediction parameters are placed as extended data.

The inter-view prediction parameters are placed as the extended data of a slice.

The inter-view prediction parameters are placed at positions that are not copied in a slice having a dependent relationship.

The inter-view prediction parameters are placed in a different area from a copy destination to which copy is performed in a slice having a dependent relationship.

The inter-view prediction parameters are parameters related to inter-view prediction.

The inter-view prediction parameter is a parameter that manages a reference relationship in inter-view prediction.

The inter-view prediction parameter is a parameter used for weighted prediction in inter-view prediction.

A receiving configured to receive the inter-view prediction parameters and the encoded stream is further included. The decoding unit can perform a decoding process on the inter-view prediction parameters received by the receiving unit, and perform a decoding process on the encoded stream received by the receiving unit, using the inter-view prediction parameters on which the decoding process has been performed.

A first image processing method of the present disclosure for an image processing apparatus includes: using inter-view prediction parameters used for inter-view prediction and performing a decoding process on an encoded stream encoded in units having a hierarchy structure in the syntax of the encoded stream where the inter-view prediction parameters are collectively placed.

A second image processing apparatus of the present disclosure performs an encoding process on image data in units having a hierarchy structure, and generates an encoded stream. Inter-view prediction parameters used for inter-view prediction are collectively placed in the syntax of the generated encoded stream. A transmission unit configured to transmit the generated encoded stream and the inter-view prediction parameters collectively placed by the placement unit is included.

The placement unit can place the inter-view prediction parameters as extended data.

The placement unit can place the inter-view prediction parameters as the extended data of a slice.

The placement unit can place the inter-view prediction parameters at positions that are not copied in a slice having a dependent relationship.

The placement unit can place the inter-view prediction parameters in a different area from a copy destination to which copy is performed in a slice having a dependent relationship.

The inter-view prediction parameters can be parameters related to inter-view prediction.

The inter-view prediction parameter is a parameter that manages a reference relationship in inter-view prediction.

The inter-view prediction parameter is a parameter used for weighted prediction in inter-view prediction.

The encoding unit can perform an encoding process on the inter-view prediction parameters. The placement unit can collectively place the inter-view prediction parameters on which the encoding process has been performed by the encoding unit.

A second aspect of the image processing method of the present disclosure for an image processing apparatus includes: performing an encoding process on image data in units having a hierarchy structure and generating an encoded stream; collectively placing inter-view prediction parameters used for inter-view prediction in the syntax of the generated encoded stream; and transmitting the generated encoded stream and the collectively placed inter-view prediction parameters.

In the first aspect of the present disclosure, inter-view prediction parameters used for inter-view prediction are used to perform a decoding process on an encoded stream encoded in units having a hierarchy structure in the syntax of the encoded stream where the inter-view prediction parameters are collectively placed.

In the second aspect of the present disclosure, an encoding process is performed on image data in units having a hierarchy structure to generate an encoded stream. Inter-view prediction parameters used for inter-view prediction are collectively placed in the syntax of the generated encoded stream. The generated encoded stream and the collectively placed inter-view prediction parameters are transmitted.

The above-mentioned image processing apparatus may be an independent apparatus, or may be an internal block configuring one image encoding apparatus or image decoding apparatus.

### Effects of the Invention

According to a first aspect of the present disclosure, an image can be decoded. Especially, the amount of encoding of a slice header of a non-base view can be reduced.

According to a second aspect of the present disclosure, an image can be encoded. Especially, the amount of encoding of a slice header of a non-base view can be reduced.

### BRIEF DESCRIPTION OF DRAWINGS

FIG. 1 is a block diagram illustrating a main configuration example of a multiview image encoding apparatus to which the present technology has been applied.

FIG. 2 is a block diagram illustrating a configuration example of an encoder.

FIG. 3 is a diagram illustrating an example of the syntax of a slice header in the HEVC format.

FIG. 4 is a diagram illustrating the syntax of the slice header.

FIG. 5 is a diagram illustrating the syntax of a slice header of the present technology.

FIG. 6 is a diagram illustrating an example of the syntax of a slice header extension.

FIG. 7 is a diagram illustrating an example of the syntax of an SPS extension.

FIG. 8 is a diagram illustrating an example of the syntax of a PPS extension.

FIG. 9 is a diagram illustrating an example of a case where a slice header can be shared.

FIG. 10 is a diagram illustrating a case where a slice header cannot be shared.

FIG. 11 is a diagram illustrating a modification of the syntax of a dependent slice.

FIG. 12 is a flowchart illustrating an example of the flow of an encoding process.

FIG. 13 is a flowchart illustrating an encoding process of a slice header of a non-base view.

FIG. 14 is a block diagram illustrating a main configuration of a multiview image decoding apparatus to which the present technology has been applied.

FIG. 15 is a block diagram illustrating a configuration example of a decoder.

FIG. 16 is a flowchart illustrating an example of the flow of a decoding process.

FIG. 17 is a flowchart illustrating a decoding process of the slice header of the non-base view.

FIG. 18 is a diagram illustrating a modification of the present technology.

FIG. 19 is a block diagram illustrating a main configuration example of a computer.

FIG. 20 is a block diagram illustrating an example of a schematic configuration of a television apparatus.

FIG. 21 is a block diagram illustrating an example of a schematic configuration of a mobile phone device.

FIG. 22 is a block diagram illustrating an example of a schematic configuration of a recording/playback apparatus.

FIG. 23 is a block diagram illustrating an example of a schematic configuration of an imaging apparatus.

### MODES FOR CARRYING OUT THE INVENTION

Hereinafter, modes for carrying out the present disclosure (hereinafter referred to as embodiments) are described. The description is given in the following order:

1. First embodiment (a multiview image encoding apparatus)

2. Second embodiment (a multiview image decoding apparatus)

3. Third embodiment (a modification)

4. Fourth embodiment (a computer)

5. Application examples

### First Embodiment

### Configuration Example of Multiview Image Encoding Apparatus

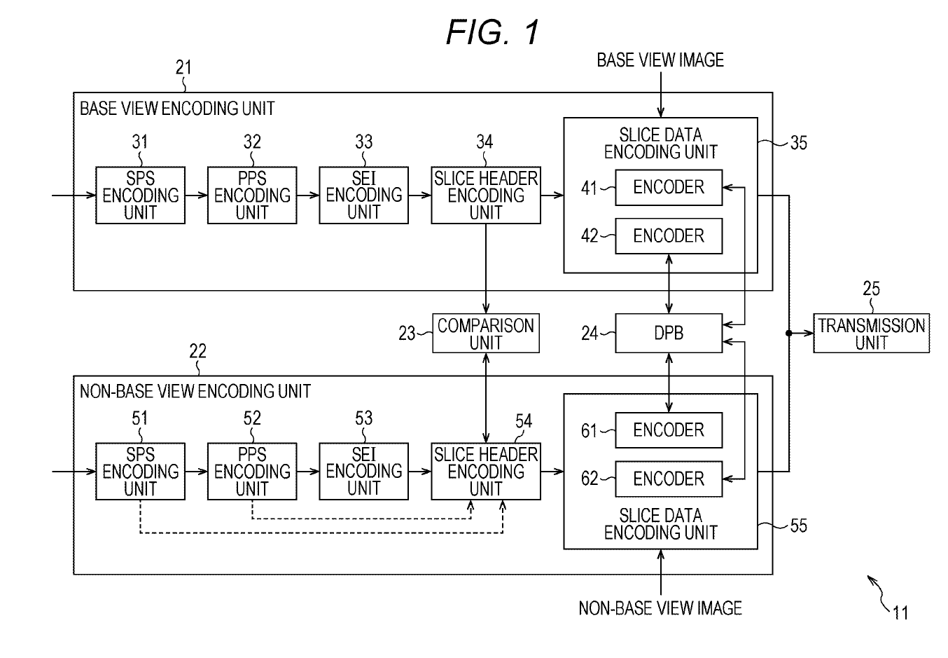

FIG. 1 presents a configuration of an embodiment of a multiview image encoding apparatus as an image processing apparatus to which the present disclosure has been applied. The example of FIG. 1 illustrates an example where a color image and a disparity information image from two views of a base view and a non-base view are encoded.

A multiview image encoding apparatus 11 of FIG. 1 is composed of a base view encoding unit 21, a non-base view encoding unit 22, a comparison unit 23, a DPB (Decoded Picture Buffer) 24, and a transmission unit 25. The multiview image encoding apparatus 11 encodes a captured (Captured) image such as a multiview image in the HEVC format.

Specifically, a color image and a disparity information image from the base view are input, frame by frame, as input signals into the base view encoding unit 21 of the multiview image encoding apparatus 11. Hereinafter, when there is no particular need to distinguish between the color image and the disparity information image, they are collectively referred to as the view image. A view image to be a base is referred to as the base view image. Moreover, a view image to be a non-base is referred to as the non-base view image. Furthermore, a view to be a base is termed the base view. A view to be a non-base is termed the non-base view.

The base view encoding unit 21 encodes the SPS (Sequence Parameter Set), the PPS (Picture Parameter Set), the SEI (Supplemental Enhancement Information), and the slice header sequentially. Moreover, the base view encoding unit 21 refers to a decoded image of the base view stored in the DPB 24 as appropriate, encodes the input signal (base view image) in the HEVC format, and obtains encoded data. The base view encoding unit 21 supplies, to the transmission unit 25, the encoded stream of the base view including the SPS, PPS, VUI, SEI, slice header, and encoded data. The SPS, PPS, VUI, SEI, and slice header are generated and encoded for each of the encoded data of the color image and the encoded data of the disparity information image.

Specifically, the base view encoding unit 21 is configured to include a SPS encoding unit 31, a PPS encoding unit 32, a SEI encoding unit 33, a slice header encoding unit 34, and a slice data encoding unit 35.

The SPS encoding unit 31 generates and encodes a SPS of the base view based on setting information by a user or the like from an unillustrated previous stage, and supplies the encoded SPS of the base view, together with the setting information, to the PPS encoding unit 32. The PPS encoding unit 32 generates and encodes a PPS of the base view based on the setting information from the SPS encoding unit 31, and supplies the encoded SPS and PPS of the base view, together with the setting information, to the SEI encoding unit 33. The SEI encoding unit 33 generates and encodes a SEI of the base view based on the setting information from the PPS encoding unit 32, and supplies the encoded SPS, PPS, and SEI of the base view, together with the setting information, to the slice header encoding unit 34.

The slice header encoding unit 34 generates and encodes a slice header of the base view based on the setting information from the SEI encoding unit 33, and supplies the encoded SPS, PPS, SEI, and slice header of the base view, together with the setting information, to the slice data encoding unit 35.

The base view image is input into the slice data encoding unit 35. The slice data encoding unit 35 is composed of an encoder 41 and an encoder 42, and encodes the base view image as slice data of the base view, based on the setting information and the like from the slice header encoding unit 34. The slice data encoding unit 35 supplies, to the transmission unit 25, the encoded SPS, PPS, SEI, and slice header of the base view, and encoded data obtained as a result of encoding.

In other words, the encoder 41 encodes the color image of the base view input as the encoding target from the outside, and supplies, to the transmission unit 25, the resultant encoded data of the color image of the base view. The encoder 42 encodes the disparity information image of the base view input as the encoding target from the outside, and supplies, to the transmission unit 25, the resultant encoded data of the disparity information image of the base view. The encoders 41 and 42 select a reference picture to refer to for encoding an encoding target image from the decoded base view images stored in the DPB 24, and encodes the image using the reference picture. At the same time, the decoded image as a result of local decoding is temporarily stored in the DPB 24.

On the other hand, a color image and a disparity information image from the non-base view (in other words, the non-base view image) are input, frame by frame, as input signals into the non-base view encoding unit 22.

The non-base view encoding unit 22 encodes the SPS, PPS, SEI, and slice header sequentially. At the same time, the non-base view encoding unit 22 encodes the slice header of the non-base view in such a manner as to collectively place parameters related to inter-view prediction in accordance with a comparison result of the slice headers by the comparison unit 23. Moreover, the non-base view encoding unit 22 uses a reference image of the base view or non-base view stored in the DPB 24 as appropriate, encodes the input signal (non-base view image) in the HEVC format, and obtains encoded data. The non-base view encoding unit 22 supplies, to the transmission unit 25, the encoded stream of the non-base view including the SPS, PPS, VUI, SEI, slice header, and encoded data.

Specifically, the non-base view encoding unit 22 is configured to include a SPS encoding unit 51, a PPS encoding unit 52, a SEI encoding unit 53, a slice header encoding unit 54, and a slice data encoding unit 55.

The SPS encoding unit 51 generates and encodes a SPS of the non-base view based on setting information by a user or the like from an unillustrated previous stage, and supplies the encoded SPS of the non-base view, together with the setting information, to the PPS encoding unit 52. Moreover, the SPS encoding unit 51 supplies, to the slice header encoding unit 54, flags necessary to generate a slice header of the non-base view within the SPS.

The PPS encoding unit 52 generates and encodes a PPS of the non-base view based on the setting information from the SPS encoding unit 51, and supplies the encoded SPS and PPS of the non-base view, together with the setting information, to the SEI encoding unit 53. Moreover, the PPS encoding unit 52 supplies, to the slice header encoding unit 54, a flag necessary to generate the slice header of the non-base view within the PPS.

The SEI encoding unit 53 generates and encodes a SEI of the non-base view based on the setting information from the PPS encoding unit 52, and supplies the encoded SPS, PPS, and SEI of the non-base view, together with the setting information, to the slice header encoding unit 54.

The slice header encoding unit 54 generates and encodes a slice header of the non-base view based on the setting information from the SEI encoding unit 53, and supplies the encoded SPS, PPS, SEI, and slice header, together with the setting information, to the slice data encoding unit 55. At the same time, the slice header encoding unit 54 refers to the flags of the SPS from the SPS encoding unit 51 and the flag of the PPS from the PPS encoding unit 52, and generates and encodes the slice header of the non-base view in such a manner as to collectively place parameters related to inter-view prediction in accordance with a comparison result of the slice headers by the comparison unit 23.

The non-base view image is input into the slice data encoding unit 55. The slice data encoding unit 55 is composed of an encoder 61 and an encoder 62, and encodes the non-base view image as slice data of the non-base view, based on the setting information and the like from the slice header encoding unit 54. The slice data encoding unit 55 supplies, to the transmission unit 25, the encoded SPS, PPS, SEI, and slice header of the non-base view, and the encoded data obtained as a result of encoding.

In other words, the encoder 61 encodes the color image of the non-base view input as the encoding target from the outside, and supplies, to the transmission unit 25, the resultant encoded data of the color image of the non-base view. The encoder 62 encodes the disparity information image of the non-base view input as the encoding target from the outside, and supplies, to the transmission unit 25, the resultant encoded data of the disparity information image of the non-base view. The encoders 61 and 62 select a reference picture to refer to for encoding the encoding target image from the decoded images of the base view or non-base view stored in the DPB 24, and encodes the image using the reference picture. In this case, the decoded image as a result of local decoding is temporarily stored in the DPB 24.

The comparison unit 23 compares the slice header of the base view and the slice header of the non-base view, and supplies the comparison result to the non-base view encoding unit 22.

The DPB 24 temporarily stores the locally decoded images (decoded images) obtained by encoding the encoding target images respectively by the encoders 41, 42, 61, and 62, and local decoding, as (candidates for) the reference picture to be referred to upon generation of a prediction image.

The DPB 24 is shared between the encoders 41, 42, 61, and 62. Accordingly, each of the encoders 41, 42, 61, and 62 can also refer to the decoded image obtained by another encoder, in addition to the decoded image obtained by itself. However, the encoders 41 and 42, which encode the base view images, refer to only images from the same view (base view).

The transmission unit 25 transmits, to a downstream decoding side, the encoded stream of the base view including the SPS, PPS, VUI, SEI, slice header, and encoded data from the base view encoding unit 21. Moreover, the transmission unit 25 transmits, to the downstream decoding side, the encoded stream of the non-base view including the SPS, PPS, VUI, SEI, slice header, and encoded data from the non-base view encoding unit 22.

### Configuration Example of Encoder

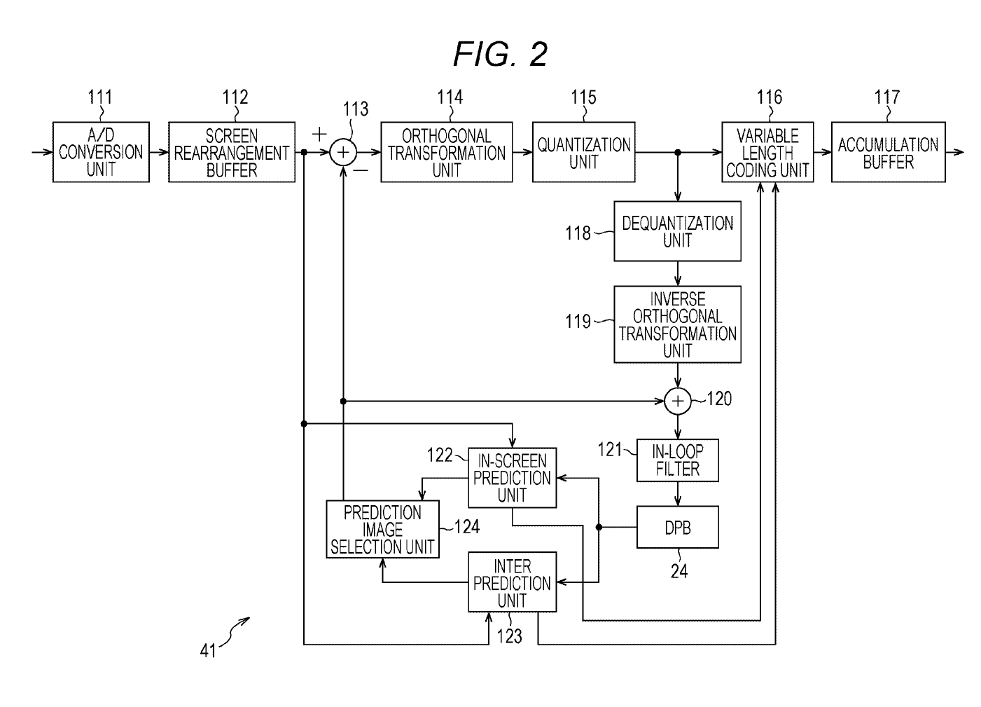

FIG. 2 is a block diagram illustrating a configuration example of the encoder 41. The encoders 42, 61, and 62 are also configured similarly to the encoder 41.

In FIG. 2, the encoder 41 includes an A/D (Analog/Digital) conversion unit 111, a screen rearrangement buffer 112, a computing unit 113, an orthogonal transformation unit 114, a quantization unit 115, a variable length coding unit 116, an accumulation buffer 117, an dequantization unit 118, an inverse orthogonal transformation unit 119, a computing unit 120, an in-loop filter 121, an in-screen prediction unit 122, an inter prediction unit 123, and a prediction image selection unit 124.

The A/D conversion unit 111 is sequentially supplied with pictures of the color image of the base view being an encoding target image (moving image) in display order.

If the pictures to be supplied to the A/D conversion unit 111 are an analog signal, the A/D conversion unit 111 A/D converts the analog signal, and supplies the signal to the screen rearrangement buffer 112.

The screen rearrangement buffer 112 temporarily stores the pictures from the A/D conversion unit 111, reads the pictures in accordance with a predetermined GOP (Group of Pictures) structure, and accordingly makes a rearrangement in which the pictures are rearranged from the display order to an encoding order (decoding order).

The pictures read from the screen rearrangement buffer 112 are supplied to the computing unit 113, the in-screen prediction unit 122, and the inter prediction unit 123.

The computing unit 113 is supplied with the pictures from the screen rearrangement buffer 112, and also supplied with the prediction image generated by the in-screen prediction unit 122 or the inter prediction unit 123, from the prediction image selection unit 124.

The computing unit 113 sets the pictures read from the screen rearrangement buffer 112 as the target pictures being the encoding target pictures, and further sets macroblocks forming the target picture sequentially as the target blocks of the encoding targets.

The computing unit 113 then performs prediction coding by computing a subtracted value by subtracting a pixel value of the prediction image supplied from the prediction image selection unit 124 from a pixel value of the target block as necessary, and supplies the target block to the orthogonal transformation unit 114.

The orthogonal transformation unit 114 performs an orthogonal transformation such as a discrete cosign transform or Karhunen-Loève transform on (the pixel value, or residual obtained by subtracting the prediction image of) the target block from the computing unit 113, and supplies the resultant transform coefficient to the quantization unit 115.

The quantization unit 115 quantizes the transform coefficient supplied from the orthogonal transformation unit 114, and supplies the resultant quantized value to the variable length coding unit 116.

The variable length coding unit 116 performs a lossless coding such as variable length coding (for example, CAVLC (Context-Adaptive Variable Length Coding)) or arithmetic coding (for example, CABAC (Context-Adaptive Binary Arithmetic Coding)) on the quantized value from the quantization unit 115, and supplies the resultant encoded data to the accumulation buffer 117.

The variable length coding unit 116 is supplied with the quantized value from the quantization unit 115, and also supplied with header information to be included in the header of the encoded data, from the in-screen prediction unit 122 or the inter prediction unit 123.

The variable length coding unit 116 encodes the header information from the in-screen prediction unit 122 or the inter prediction unit 123 and includes the header information in the header of the encoded data.

The accumulation buffer 117 temporarily stores the encoded data from the variable length coding unit 116 and outputs the encoded data at a predetermined data rate.

The encoded data output from the accumulation buffer 117 is supplied to the transmission unit 25 of FIG. 1.

The quantized value obtained by the quantization unit 115 is supplied to the variable length coding unit 116 and also to the dequantization unit 118. Local decoding is performed in the dequantization unit 118, the inverse orthogonal transformation unit 119, and the computing unit 120.

In other words, the dequantization unit 118 dequantizes the quantized value from the quantization unit 115 into a transform coefficient and supplies the transform coefficient to the inverse orthogonal transformation unit 119.

The inverse orthogonal transformation unit 119 performs an inverse orthogonal transformation on the transform coefficient from the dequantization unit 118, and supplies the data to the computing unit 120.

The computing unit 120 adds the pixel value of the prediction image supplied from the prediction image selection unit 124 to the data supplied from the inverse orthogonal transformation unit 119 as necessary, and accordingly obtains a decoded image where the target block has been decoded (locally decoded) to supply the decoded image to the in-loop filter 121.

The in-loop filter 121 is composed of, for example, a deblocking filter. For example, if the HEVC format is adopted, the in-loop filter 121 is composed of a deblocking filter and a sample adaptive offset filter (Sample Adaptive Offset: SAO). The in-loop filter 121 filters the decoded image from the computing unit 120, and accordingly removes (reduces) block noise caused in the decoded image to supply the decoded image to the DPB 24.

Here, the DPB 24 stores the decoded image from the in-loop filter 121, in other words, the picture of the color image of the base view encoded in the encoder 41 and locally decoded as (a candidate for) the reference picture to be referred to upon generation of a prediction image used for prediction coding (coding where a subtraction of a prediction image is performed in the computing unit 113) to be performed temporally later.

As described in FIG. 1, the DPB 24 is shared between the encoders 41, 42, 61, and 62. Accordingly, in addition to the picture of the color image of the base view encoded in the encoder 41 and locally decoded, the picture of the disparity information image of the base view encoded in the encoder 42 and locally decoded, the picture of the color image of the non-base view encoded in the encoder 61 and locally decoded, and the picture of the disparity information image of the non-base view encoded in the encoder 62 and locally decoded are also stored.

Local decoding by the dequantization unit 118, the inverse orthogonal transformation unit 119, and the computing unit 120 is performed targeting, for example, I pictures, P pictures, and Bs pictures being referable pictures that can be reference pictures, and decoded images of the I pictures, P pictures, and Bs pictures are stored in the DPB 24.

If the target picture is the I picture, P picture, or B picture (including the Bs picture) that can be intra predicted (in-screen predicted), the in-screen prediction unit 122 reads the already locally decoded part (decoded image) of the target picture from the DPB 24. The in-screen prediction unit 122 then sets a part of the decoded image, read from the DPB 24, of the target picture as the prediction image of the target block of the target picture supplied from the screen rearrangement buffer 112.

Furthermore, the in-screen prediction unit 122 obtains a coding cost required to encode the target block using the prediction image, in other words, a coding cost required to encode the residual and the like of the target block for the prediction image, and supplies the coding cost together with the prediction image to the prediction image selection unit 124.

If the target picture is the P picture or B picture (including the Bs picture) that can be inter predicted, the inter prediction unit 123 reads, from the DPB 24, one or more pictures encoded and locally decoded before the target picture as a candidate picture(s) (a candidate(s) for the reference picture).

Moreover, the inter prediction unit 123 detects a displacement vector indicating motion as a displacement (temporal displacement) between the target block of the target picture from the screen rearrangement buffer 112 and a corresponding block of the candidate picture corresponding to the target block (a block that minimizes SAD (Sum of Absolute Differences) in between with the target block) by ME (Motion Estimation) (motion detection) using the target block and the candidate picture.

The inter prediction unit 123 performs motion compensation that compensates the displacement equivalent to the motion of the candidate picture from the DPB 24 in accordance with the displacement vector of the target block and accordingly generates a prediction image.

In other words, the inter prediction unit 123 acquires, as the prediction image, the corresponding block of the candidate picture being a block (area) at a position moved (displaced) from the position of the target block in accordance with the displacement vector of the target block.

Furthermore, the inter prediction unit 123 obtains the coding cost required to encode the target block using the prediction image for each inter prediction mode in which the candidate picture used to generate a prediction image, and the macroblock type are different.

The inter prediction unit 123 then sets an inter prediction mode having a minimum coding cost as an optimum inter prediction mode being an optimum inter prediction mode, and supplies the prediction image obtained in the optimum inter prediction mode, and the coding cost, to the prediction image selection unit 124.

The prediction image selection unit 124 selects a prediction image having a smaller coding cost from the prediction images from both the in-screen prediction unit 122 and the inter prediction unit 123, and supplies the prediction image to the computing units 113 and 120.

Here, the in-screen prediction unit 122 supplies information related to intra prediction as the header information to the variable length coding unit 116. The inter prediction unit 123 supplies information related to inter prediction (information on the displacement vector, and the like) as the header information to the variable length coding unit 116.

The variable length coding unit 116 selects header information of the generated prediction image having the smaller coding cost, from the header information of both the in-screen prediction unit 122 and the interprediction unit 123, and includes the header information in the header of the encoded data.

### Example of Syntax of Slice Header in HEVC Format

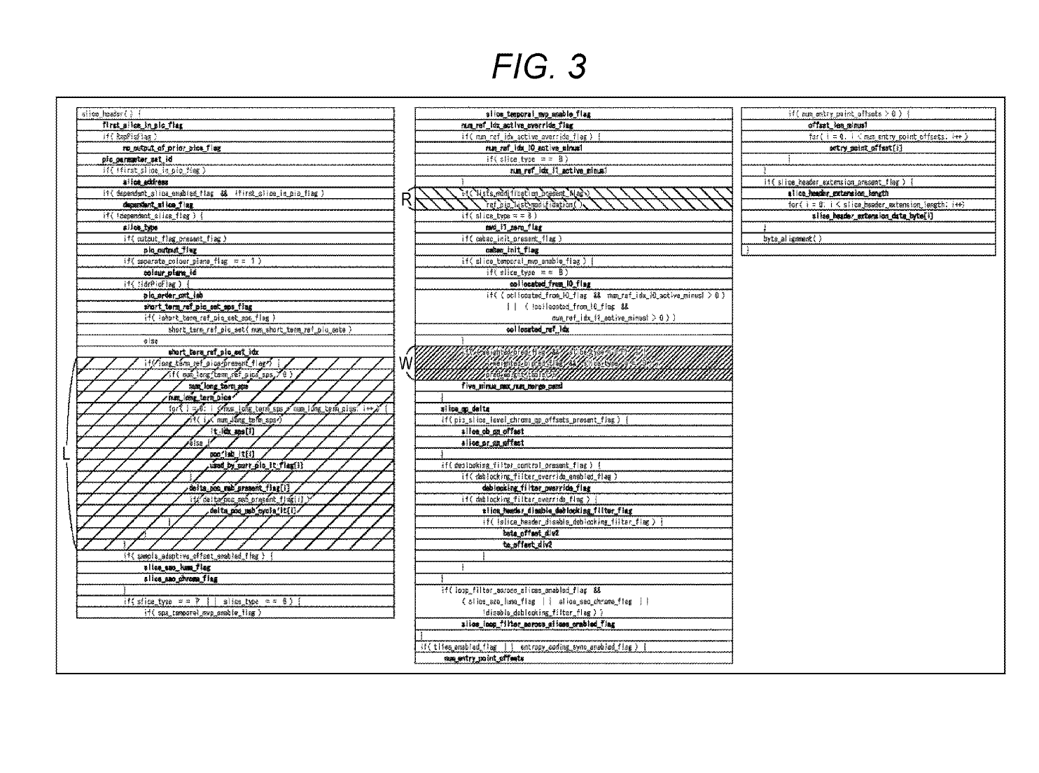

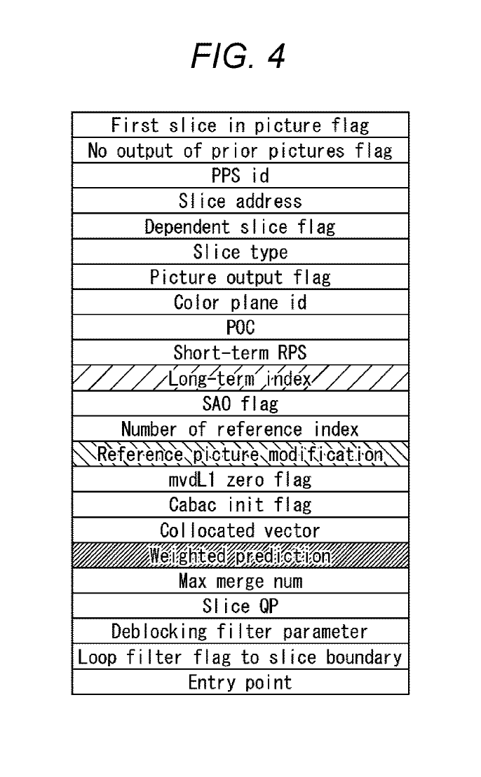

FIG. 3 is a diagram illustrating an example of the syntax of a slice header in the HEVC format. FIG. 4 presents the abbreviated syntax of FIG. 3.

In the current draft of HEVC, a dependent slice (Dependent slice: a slice having a dependent relationship) is adopted as one of parallel processing tools. The use of the dependent slice makes it possible to copy a major part of a slice header of an immediately previous slice. Consequently, the amount of encoding of the slice header can be reduced.

When multiview coding is considered, it is assumed that a major part of the syntax of the slice header is common between views. Hence, it is conceivable to apply the dependent slice between views. However, the slice header contains, for example, syntaxes difficult to be shared between views, in other words, inter-view prediction parameters used for inter-view prediction.

For example, a hatched part assigned with L within the slice header illustrated in FIG. 3 is a part for setting a Long-term index (correctly, Long-term picture index) illustrated in FIG. 4. In the slice header, the Long-term index is a parameter for explicitly specifying the inter prediction image, and the inter-view prediction image.

In the Long-term index, the inter-view prediction image is specified as a Long-term picture. In the non-base view, this index is always used to specify the inter-view prediction image.

Within the slice header illustrated in FIG. 3, a hatched part assigned with R is a part for setting Reference picture modification (correctly, Reference picture list modification) illustrated in FIG. 4. In the slice header, Reference picture modification is a parameter for managing the reference pictures in inter prediction and inter-view prediction.

In Reference picture modification, a Long-term picture is added to the end of the reference list. In the non-base view, the list may be frequently changed, for example, by assigning a smaller reference index to the inter-view prediction image, to improve encoding efficiency.

Within the slice header illustrated in FIG. 3, a hatched part assigned with W is a part for setting Weighted prediction illustrated in FIG. 4. In the slice header, Weighted prediction is a parameter used for weighted prediction in inter prediction and inter-view prediction.

The use of Weighted prediction makes it possible to correct the luminance of the inter-view prediction image. A difference in luminance between views may be caused due to a difference in camera properties. In the non-base view, Weighted prediction is considered to be frequently used to improve the encoding efficiency.

In other words, the Long-term index is a parameter used for inter-view prediction. In contrast, Reference picture modification and Weighted prediction are parameters for efficient inter-view prediction. In other words, the three parameters are the parameters (syntaxes) related to inter-view prediction, and are the inter-view prediction parameters used for inter-view prediction.

The syntaxes related to inter-view prediction described above can be changed by performing inter-view prediction, and are used for the non-base view but not used for the base view.

In the case of HEVC, these syntaxes are present in a part to be copied (a part to be shared) in the slice header of the dependent slice. Accordingly, the dependent slice cannot substantially be used between views.

In Cited Document 2, for example, Non-Patent Document 2 proposes a Header parameter Set (HPS) that sets a flag and shares parameters between parameter sets, slice headers, or the like, for the purpose of reducing the amount of encoding of the slice header. However, Cited Document 2 does not have a description related to collectively place parameters focusing on the ease of sharing inter-view prediction, as in the present technology.

Hence, in the multiview image encoding apparatus 11, the syntaxes related to inter-view prediction being the syntaxes that are difficult to be shared in the part shared in the dependent slice (hereinafter simply referred to as the shared part) are configured to be collectively placed at, for example, a position different from the existing header.

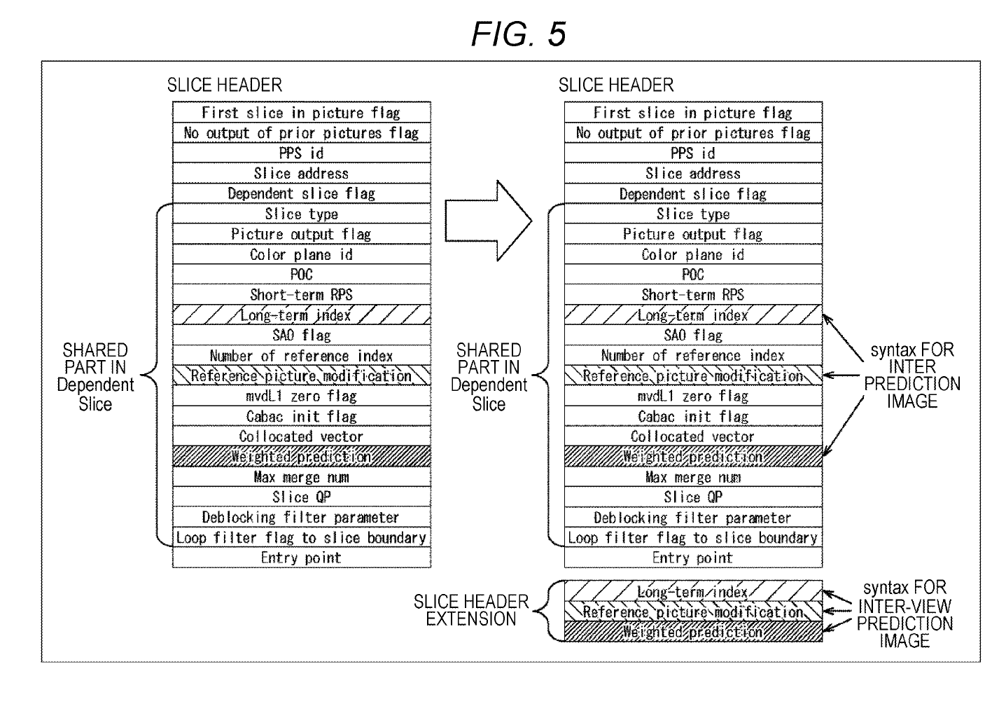

In the slice header, as illustrated in FIG. 5, the shared part to be shared (copied and used) in the dependent slice is below a Dependent slice flag in the fifth line from the top and above an Entry point in the last line. In other words, if the Dependent slice flag is 1, the dependent slice is shared below the Dependent slice flag and above the Entry point in the last line.

In the shared part of the dependent slice, values for the inter prediction image within the above-mentioned Long-term index, Reference picture modification, and Weighted prediction are placed at predetermined positions of the existing slice header. Consequently, it becomes possible to be shared with the syntax of the base view.

On the other hand, values for the inter-view prediction image within the above-mentioned Long-term index, Reference picture modification, and Weighted prediction are collectively placed in an area different from the slice header. For example, as illustrated in the right side of FIG. 5, the syntaxes for the inter-view prediction image are collectively placed in order to be able to be redefined as a slice header extension (as the extended data of the slice header).

From the above, it becomes possible in the non-base view to reduce the amount of encoding of the slice header using the dependent slice.

Here, collectively (arranging) placing the syntaxes for the inter-view prediction image indicates collectively placing a major part of the slice header in order to make it possible to share the major part of the slice header between the base view and the non-base view. In other words, collectively placing indicates collectively placing the syntaxes that are different between the base view and the non-base view in order to prevent them from being placed in the area shared in the dependent slice.

Moreover, as long as the syntaxes for the inter-view prediction image are collectively placed, the placement position is not particularly limited. For example, the placement location may be within or outside the slice header. Moreover, as described in FIG. 5, the syntaxes may be placed as the extended data of the slice header. Alternatively, they may be placed as the extended data of another syntax. Moreover, upon placement, it is better if they are placed at positions that are not shared in the dependent slice or in an area different from a copy destination to which copy is performed in the dependent slice.

Furthermore, the syntaxes for the inter-view prediction image may be collectively placed and then encoded, or may be encoded and then collectively placed. In other words, in terms of the order of encoding and placement, either can come first.

In the above description, the description was given of the example where the Long-term index, Reference picture modification, and Weighted prediction are left and the values for the inter prediction image are defined in the part shared in the dependent slice of the slice header. In contrast, the Long-term index, Reference picture modification, and Weighted prediction may be removed from the part shared in the dependent slice and may all be collectively placed.

However, while there is almost no need to change the syntax and semantics of the dependent slice in the former case, there is a need to change the syntax and semantics of the dependent slice in the latter case.

### Example of Syntax of Slice Header Extension

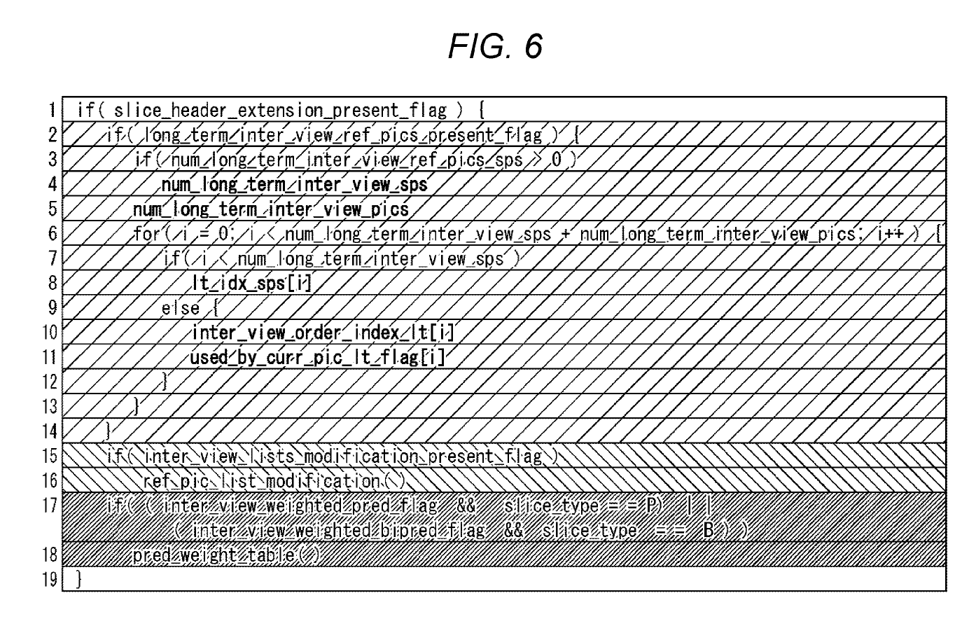

FIG. 6 is a diagram illustrating an example of the syntax of the slice header extension. The numeral at the left end of each line is a line number assigned for description.

In the example of FIG. 6, the Long-term picture index is set in the second to fourteenth lines. As described above with reference to FIG. 5, the inter-view prediction image is specified in the Long-term picture index of the slice header extension.

Reference picture list modification is set in the fifteenth and sixteenth lines. As described above with reference to FIG. 5, the value for inter-view prediction out of the parameters used for weighted prediction is set in Reference picture list modification of the slice header extension.

Weighted prediction is set in the seventeenth and eighteenth lines. As described above with reference to FIG. 5, the value for inter-view prediction out of the parameters for managing the reference pictures is set in Weighted prediction of the slice header extension.

The description related to inter prediction and the description related to inter-view prediction can be given separately in the Long-term picture index. Accordingly, the description related to inter prediction is defined in the shared part, and the description related to inter-view prediction is defined in the extension.

However, in terms of Reference picture list modification and Weighted prediction, the description related to inter prediction and the description related to inter-view prediction are not given separately. Therefore, in terms of Reference picture list modification and Weighted prediction, those defined in the slice header are overwritten with those defined in the slice header extension.

Also in terms of Reference picture list modification and Weighted prediction, it may be configured as in the Long-term picture index that the description related to inter prediction and the description related to inter-view description are given separately, the description related to inter prediction is defined in the shared part, and the description related to inter-view prediction is defined in the extension.

### Example of Syntax of SPS Extension

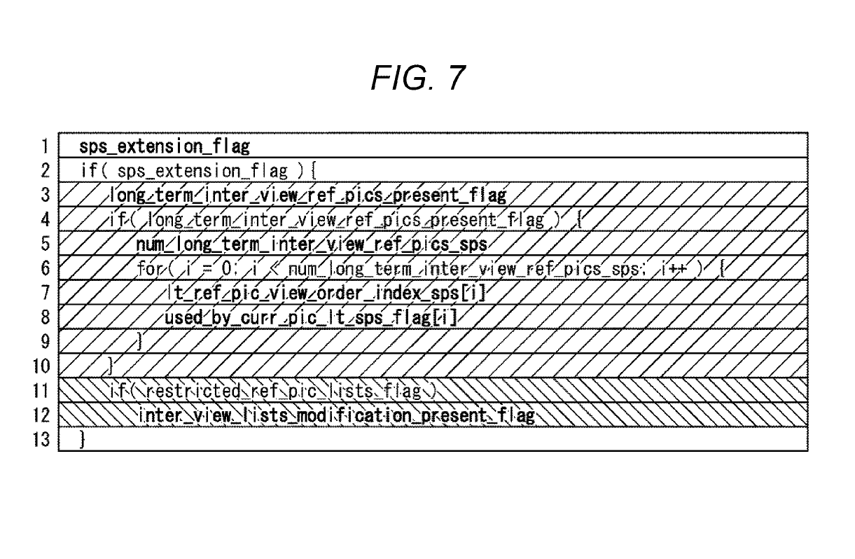

FIG. 7 is a diagram illustrating an example of the syntax of an SPS extension defined for the slice header extension illustrated in FIG. 6. The numeral at the left end of each line is a line number assigned for description.

In the example of FIG. 7, a Long term picture list related to the Long-term picture index is defined in the third to tenth lines. Especially, Long_term_inter_view_ref_pics_present_flag is defined in the third line. This flag is a flag for the Long-term picture index. If the value is 1, it indicates that the Long-term picture index in the slice header extension is set, and it is necessary to refer to the Long-term picture index.

inter_view_lists_modification_present_flag is defined in the twelfth and thirteenth lines. This flag is a flag for Reference picture list modification. If the value is 1, it indicates Reference picture list modification in the slice header extension is set, and it is necessary to refer to Reference picture list modification.

### Example of Syntax of PPS Extension

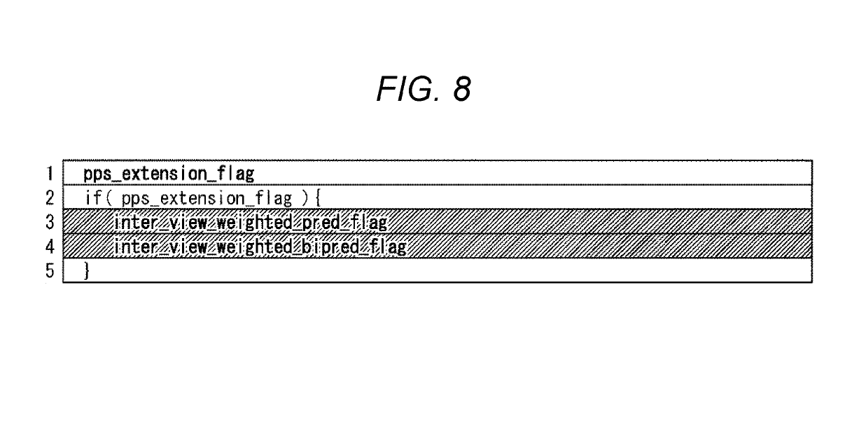

FIG. 8 is a diagram illustrating an example of the syntax of a PPS extension defined for the slice header extension illustrated in FIG. 6. The numeral at the left end of each line is a line number assigned for description.

In the example of FIG. 8, inter_view_weighted_pred_flag and inter_view_weighted_bipred_flag are defined in the third and fourth lines. These flags are flags for Weighted prediction. If their values are one, it indicates that Weighted prediction in the slice header extension is set and it is necessary to refer to Weighted prediction.

### Regarding Sharing Slice Header

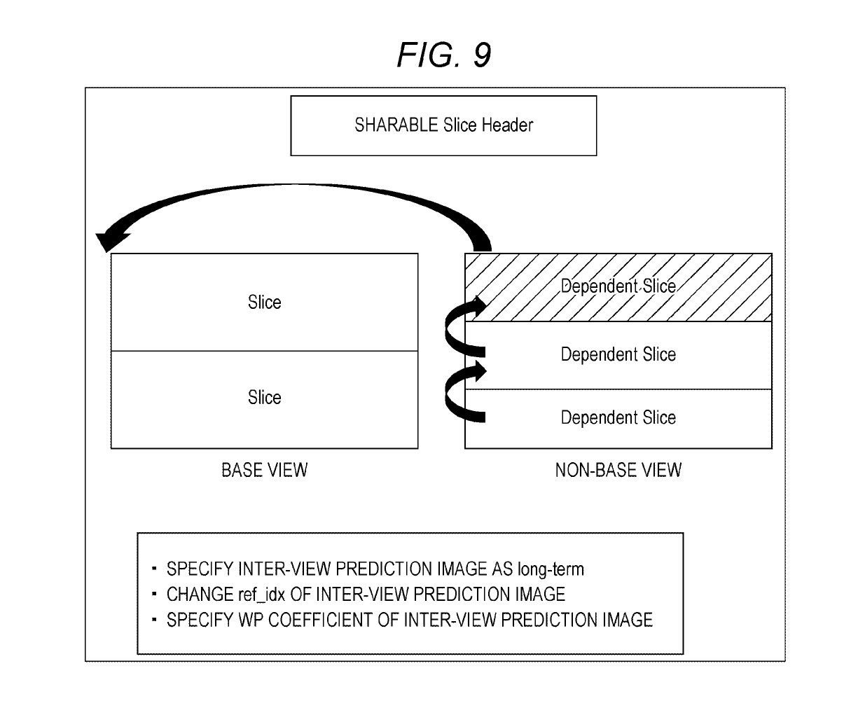

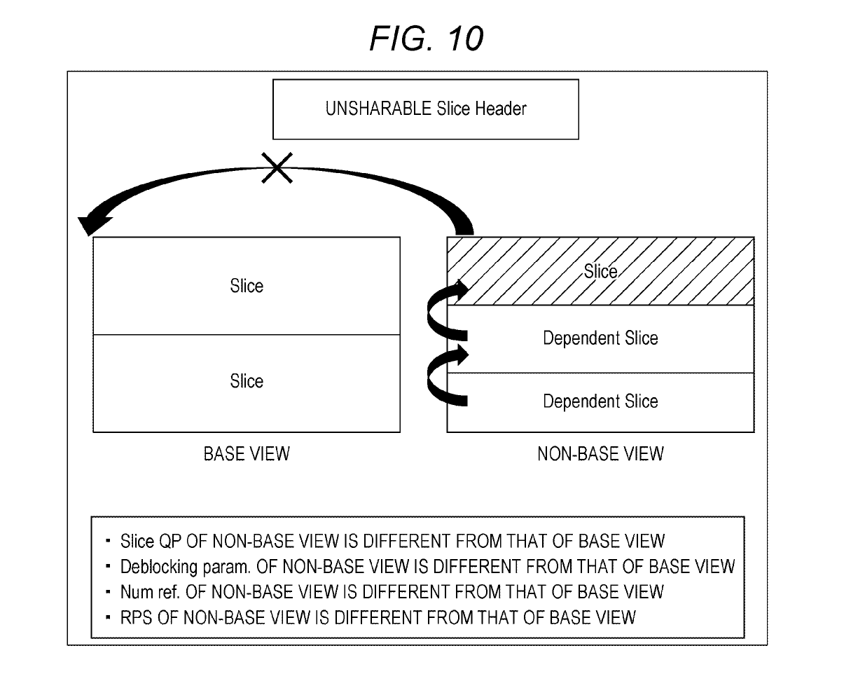

Next, a description is given for whether or not the slice header can be shared with reference to FIGS. 9 and 10. The example of FIG. 9 illustrates an example of a case where a slice of the non-base view can share a slice header with a slice of the base view.

In the example of FIG. 9, the base view includes two slices (slice). The non-base view includes three dependent slices (Dependent Slice).

A third dependent slice from the top of the non-base view can share a slice header of a second dependent slice from the top of the non-base view. The second dependent slice from the top of the non-base view can share a slice header of a first dependent slice from the top of the non-base view.

In the case of the present technology, in the slice header extension, the inter-view prediction image is specified as long-term, ref_idx of the inter-view prediction image is changed, and a WP (Weighted prediction) coefficient of the inter-view prediction image is specified. Under such conditions, the first dependent slice from the top of the non-base view can share a slice header of a first slice from the top of the base view.

In contrast, the example of FIG. 10 illustrates an example of a case where the slice header cannot be shared. The example of FIG. 10 illustrates an example where a slice of the non-base view cannot share a slice header with a slice of the base view.

In the example of FIG. 10, the base view includes two slices. The non-base view includes one slice and two dependent slices.

A third dependent slice from the top of the non-base view can share a slice header of a second dependent slice from the top of the non-base view. The second dependent slice from the top of the non-base view can share a slice header of a first dependent slice from the top of the non-base view.

For example, a slice QP (Slice QP) of the non-base view is different from a slice QP of the base view. A deblocking parameter (Deblocking param.) of the non-base view is different from a deblocking parameter of the base view. Num ref. of the non-base view is different from Num ref. of the base view. A RPS of the non-base view is different from a RPS of the base view.

Therefore, from such reasons, even if the present technology is applied, the first slice from the top of the non-base view cannot share a slice header of a first slice from the top of the next base view in the case of the example of FIG. 10.

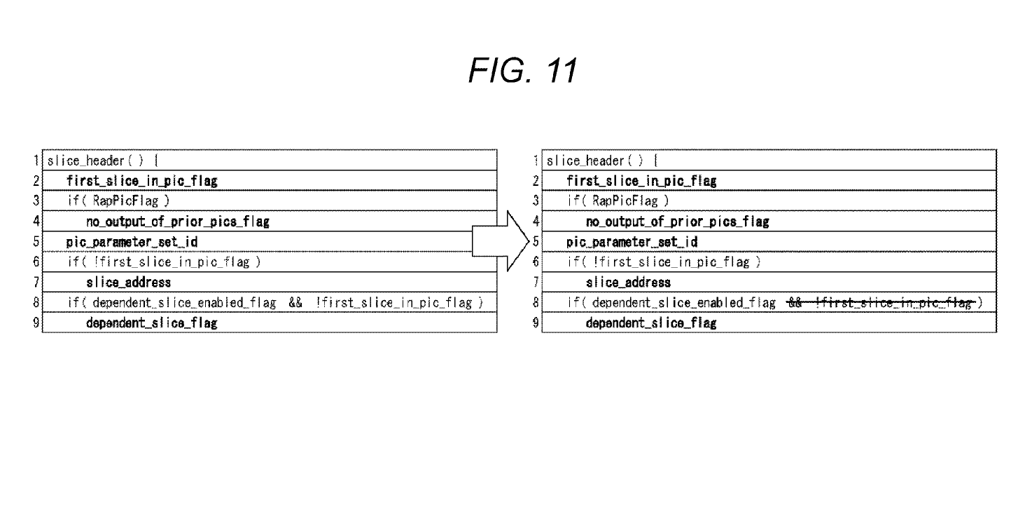

Next, a description is given for the modification of the syntax and semantics of the dependent slice with reference to FIG. 11. FIG. 11 is a diagram illustrating an example of the syntax of the slice header.

In the semantics of the dependent slice of the current HEVC, a slice at the start of a picture cannot be the dependent slice. In contrast, in a case where the present technology is applied, when the dependent slice is used at the start of a picture in the non-base view, it is necessary to modify the semantics for copying the slice header of the base view.

Moreover, in the semantics of the dependent slice of the current HEVC, the dependent slice inherits a probability table of an immediately previous slice. In contrast, in a case where the present technology is applied, when the dependent slice is used at the start of a picture in the non-base view, it is necessary to modify the semantics for initializing the probability table.

In the syntax, it is necessary to make a modification in the eighth line of the slice header, deleting && !first_slice_in_pic_flag from the description of if (dependent_slice_enabled_flag&&!first_slice_in_pic_flag), and placing if (dependent_slice_enabled_flag).

Consequently, in the non-base view, it is possible to reduce the amount of encoding of the slice header, using the dependent slice.

### Operation of Multiview Image Encoding Apparatus

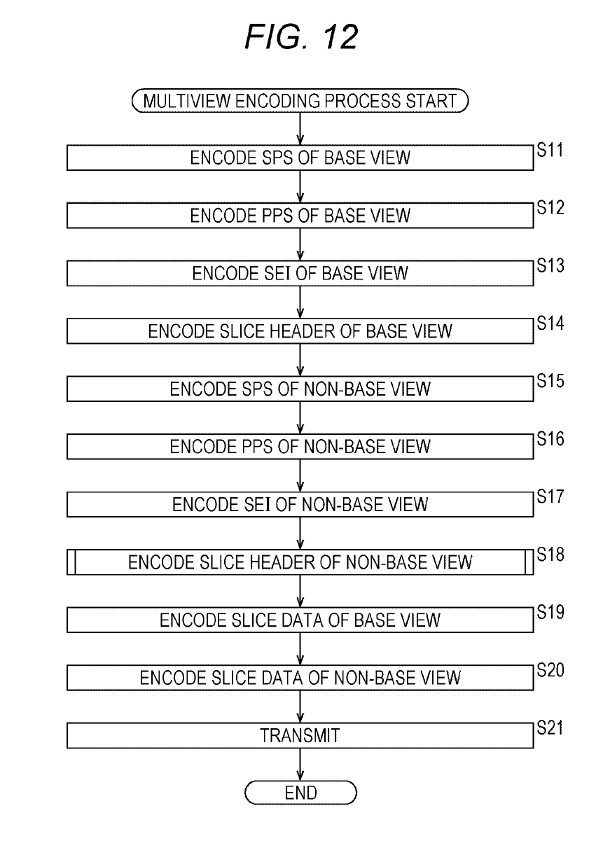

Next, a description is given for a multiview image encoding process as the operation of the multiview image encoding apparatus 11 of FIG. 1 with reference to a flowchart of FIG. 12.

In Step S11, the SPS encoding unit 31 generates and encodes a SPS of the base view based on setting information by a user or the like from the unillustrated previous stage, and supplies the encoded SPS of the base view, together with the setting information, to the PPS encoding unit 32.

In Step S12, the PPS encoding unit 32 generates and encodes a PPS of the base view based on the setting information from the SPS encoding unit 31, and supplies the encoded SPS and PPS of the base view, together with the setting information, to the SEI encoding unit 33.

In Step S13, the SEI encoding unit 33 generates and encodes a SEI of the base view based on the setting information from the PPS encoding unit 32, and supplies the encoded SPS, PPS, and SEI of the base view, together with the setting information, to the slice header encoding unit 34.

In Step S14, the slice header encoding unit 34 generates and encodes a slice header of the base view based on the setting information from the SEI encoding unit 33. The slice header encoding unit 34 then supplies the encoded SPS, PPS, SEI, and slice header of the base view, together with the setting information, to the slice data encoding unit 35.

On the other hand, in Step S15, the SPS encoding unit 51 generates and encodes a SPS of the non-base view based on setting information by the user or the like from the unillustrated previous stage, and supplies the encoded SPS of the non-base view, together with the setting information, to the PPS encoding unit 52.

At the same time, the SPS encoding unit 51 supplies, to the slice header encoding unit 54, flags necessary to generate the slice header of the non-base view within the SPS. Specifically, the flag for the Long-term picture index and the flag for Reference picture list modification in the SPS extension of FIG. 7 are supplied to the slice header encoding unit 54.

In Step S16, the PPS encoding unit 52 generates and encodes a PPS of the non-base view based on the setting information from the SPS encoding unit 51, and supplies the encoded SPS and PPS of the non-base view, together with the setting information, to the SEI encoding unit 53.

At the same time, the PPS encoding unit 52 supplies, to the slice header encoding unit 54, a flag necessary to generate the slice header of the non-base view within the PPS. Specifically, the flags for Weighted prediction in the PPS extension of FIG. 8 are supplied to the slice header encoding unit 54.

In Step S17, the SEI encoding unit 53 generates and encodes a SEI of the non-base view based on the setting information from the PPS encoding unit 52, and supplies the encoded SPS, PPS, and SEI of the non-base view, together with the setting information, to the slice header encoding unit 54.

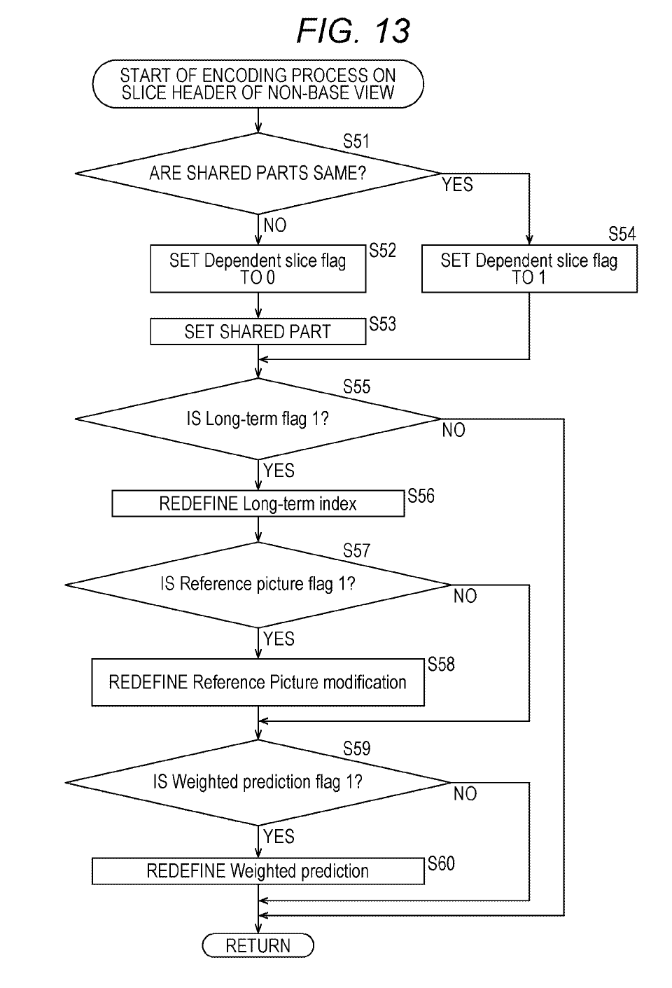

In Step S18, the slice header encoding unit 54 generates and encodes a slice header of the non-base view based on the setting information from the SEI encoding unit 53. The encoding process of the slice header of the non-base view is described below with reference to FIG. 13.

In Step S18, the slice header of the non-base view is generated and encoded such that the inter-view prediction syntaxes (parameters)) are collectively placed in accordance with the flags of the SPS from the SPS encoding unit 51, the flag of the PPS from the PPS encoding unit 52, and a comparison result between the slice headers by the comparison unit 24. The encoded SPS, PPS, SEI, and slice header, together with the setting information, are supplied to the slice data encoding unit 55.

The base view image is input into the slice data encoding unit 35. In Step S19, the slice data encoding unit 35 encodes the base view image as slice data of the base view, based on the setting information and the like from the slice header encoding unit 34. The slice data encoding unit 35 supplies, to the transmission unit 25, the encoded SPS, PPS, SEI, and slice header of the base view, and the encoded data obtained as a result of encoding.

The non-base view image is input into the slice data encoding unit 55. In Step S20, the slice data encoding unit 55 encodes the non-base view image as slice data of the non-base view, based on the setting information and the like from the slice header encoding unit 54. The slice data encoding unit 55 supplies, to the transmission unit 25, the encoded SPS, PPS, SEI, and slice header of the non-base view, and the encoded data obtained as a result of encoding.

In Step S21, the transmission unit 25 transmits, to the downstream decoding side, the encoded stream of the base view image including the SPS, PPS, VUI, SEI, slice header, and encoded data from the base view encoding unit 21. Moreover, the transmission unit 25 transmits, to the downstream decoding side, the encoded stream of the non-base view image including the SPS, PPS, VUI, SEI, slice header, and encoded data from the non-base view encoding unit 22.

As described above, in the slice header of the non-base view, the inter-view prediction syntaxes (parameters) are configured to be collectively placed. Accordingly, the dependent slice can be used in the non-base view. As a result, the amount of encoding of the slice header in the non-base view can be reduced.

### Example of Slice Header Encoding Process of Non-base View

Next, a description is given for the slice header encoding process of the non-base view of Step S18 of FIG. 12 with reference to a flowchart of FIG. 13.

The comparison unit 23 acquires the slice header of the base view generated by the slice header encoding unit 34 and the slice header of the non-base view now generated by the slice header encoding unit 54, and compares them to determine whether their shared parts are the same. The comparison unit 23 supplies the comparison result to the slice header encoding unit 54.

In Step S51, the slice header encoding unit 54 determines whether or not the shared part of the slice header of the base view and the shared part of the slice header of the non-base view are the same.

The values for the inter prediction image are set in the Long-term index, Reference picture modification, and Weighted prediction in the shared part.

If it is determined that the shared parts are not the same in Step S51, the execution proceeds to Step S52. The slice header encoding unit 54 sets the Dependent slice flag placed before the shared part to 0 in Step S52, and sets the shared part for the non-base view in Step S53.

On the other hand, if it is determined that the shared parts are the same in Step S51, the execution proceeds to Step S54. The slice header encoding unit 54 sets the Dependent slice flag placed before the shared part to 1 in Step S54. In this case, the shared part is copied on the decoding side and is not set.

In Step S55, the slice header encoding unit 54 determines whether or not the Long-term flag (the flag for the Long-term picture index) in the SPS extension supplied in Step S15 of FIG. 12 is 1.

If it is determined that the Long-term flag is 1 in Step S55, the execution proceeds to Step S56. In Step S56, the slice header encoding unit 54 redefines the Long-term picture index as the slice header extension.

If it is determined that the Long-term flag is 0 in Step S55, the processing from Steps S56 to S60 is skipped, and the encoding process ends. In other words, if the Long-term flag is 0, inter-view prediction is not used. Accordingly, both the Reference picture flag and the Weighted prediction flag become 0.

In Step S57, the slice header encoding unit 54 determines whether or not the Reference picture flag (the flag for Reference picture list modification) in the SPS extension supplied in Step S15 of FIG. 12 is 1.

If it is determined that the Reference picture flag is 1 in Step S57, the execution proceeds to Step S58. In Step S58, the slice header encoding unit 54 redefines Reference picture list modification as the slice header extension.

If it is determined that the Reference picture flag is 0 in Step S57, the processing of Step S58 is skipped and the execution proceeds to Step S59.

In Step S59, the slice header encoding unit 54 determines whether or not the Weighted prediction flag (the flag for Weighted prediction) in the PPS extension supplied in Step S16 of FIG. 12 is 1.

If it is determined that the Weighted prediction flag is 1 in Step S59, the execution proceeds to Step S60. In Step S60, the slice header encoding unit 54 redefines Weighted prediction as the slice header extension.

In other words, in Steps S56, S58, and S60, the slice header encoding unit 54 collectively places the Long-term picture index, Weighted prediction, and Weighted prediction, which are the inter-view prediction parameters used for inter-view prediction, as the slice header extension.

If it is determined that the Weighted prediction flag is 0 in Step S59, the processing of Step S60 is skipped.

As described above, in the encoding of the non-base view, the syntaxes (parameters) related to inter-view prediction are placed as the slice header extension, and the slice header of the non-base view is encoded. The execution then returns to Step S18 of FIG. 12, and proceeds to Step S19.

### Second Embodiment

### Configuration Example of Multiview Image Decoding Apparatus

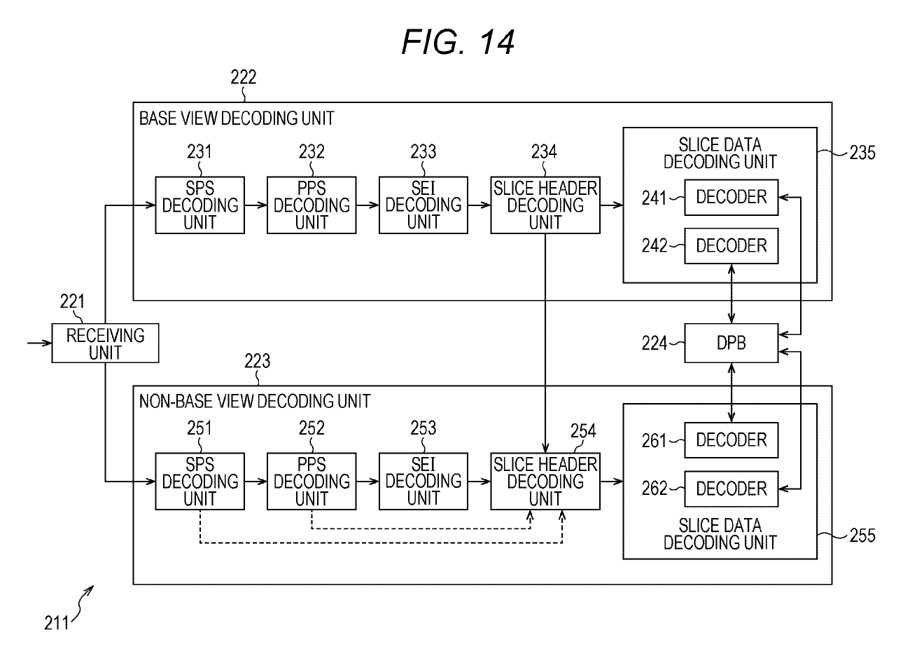

FIG. 14 presents a configuration of an embodiment of a multiview image decoding apparatus as an image processing apparatus to which the present disclosure has been applied. A multiview image decoding apparatus 211 of FIG. 14 decodes the encoded stream encoded by the multiview image encoding apparatus 11 of FIG. 1. In other words, in the encoded stream, the inter-view prediction parameters used for inter-view prediction are collectively placed in the slice header of the non-base view.

The multiview image decoding apparatus 211 of FIG. 14 is configured to include a receiving unit 221, abase view decoding unit 222, a non-base view decoding unit 223, and a DPB 224. The multiview image decoding apparatus 211 receives the encoded stream transmitted from the multiview image encoding apparatus 11, and decodes the encoded data of the base view image and the encoded data of the non-base view image.

The receiving unit 221 receives the encoded stream transmitted from the multiview image encoding apparatus 11 of FIG. 1. The receiving unit 221 separates, from the received bitstream, the encoded data of the color image of the base view, the encoded data of the disparity information image of the base view, the encoded data of the color image of the non-base view, and the encoded data of the disparity information image of the non-base view.

The receiving unit 221 then supplies, to the base view decoding unit 222, the encoded data of the color image of the base view and the encoded data of the disparity information image of the base view. The receiving unit 221 supplies, to the non-base view decoding unit 223, the encoded data of the color image of the non-base view and the encoded data of the disparity information image of the non-base view.

The base view decoding unit 222 extracts the SPS, PPS, SEI, and slice header, respectively from the encoded data of the color image of the base view and the encoded data of the disparity information image of the base view, and decodes them sequentially. The base view decoding unit 222 then refers to the decoded image of the base view stored in the DPB 224 based on the information on the decoded SPS, PPS, SEI, and slice header as appropriate, and decodes each of the encoded data of the color image of the base view and the encoded data of the disparity information image of the base view.

Specifically, the base view decoding unit 222 is configured to include a SPS decoding unit 231, a PPS decoding unit 232, a SEI decoding unit 233, a slice header decoding unit 234, and a slice data decoding unit 235.

The SPS decoding unit 231 extracts the SPS of the base view from the encoded data of the base view, decodes the SPS, and supplies the encoded data and the decoded SPS to the PPS decoding unit 232. The PPS decoding unit 232 extracts the PPS of the base view from the encoded data of the base view, decodes the PPS, and supplies the encoded data and the decoded SPS and PPS to the SEI decoding unit 233. The SEI decoding unit 233 extracts the SEI of the base view from the encoded data of the base view, decodes the SEI, and supplies the encoded data and the decoded SPS, PPS, and SEI to the slice header decoding unit 234.

The slice header decoding unit 234 extracts the slice header from the encoded data of the base view, decodes the slice header, and supplies the encoded data and the decoded SPS, PPS, SEI, and slice header to the slice data decoding unit 235.

The slice data decoding unit 235 is composed of a decoder 241 and a decoder 242. The slice data decoding unit 235 decodes the encoded data of the base view based on the SPS, PPS, SEI, slice header, and the like from the slice header decoding unit 234, and generates a base view image being the slice data of the base view.

In other words, the decoder 241 decodes the encoded data of the base view based on the SPS, PPS, SEI, slice header, and the like from the slice header decoding unit 234, and generates a color image of the base view. The decoder 242 decodes the encoded data of the base view based on the SPS, PPS, SEI, slice header, and the like from the slice header decoding unit 234, and generates a disparity information image of the base view. The decoders 241 and 242 select a reference picture to be referred to for decoding a decoding target image from the decoded images of the base view stored in the DPB 224, to decode the image using the reference picture. In this case, the decoded image as a result of decoding is temporarily stored in the DPB 224.

On the other hand, the non-base view decoding unit 223 extracts the SPS, PPS, SEI, and slice header, respectively from the encoded data of the color image of the non-base view, and the encoded data of the disparity information image of the non-base view, and decodes them sequentially. In this case, the non-base view decoding unit 223 decodes the slice header of the non-base view in accordance with the dependent slice flag of the slice header. The non-base view decoding unit 223 then refers to the decoded image of the base view stored in the DPB 224 based on the information on the decoded SPS, PPS, SEI, and slice header as appropriate, and decodes each of the encoded data of the color image of the non-base view and the encoded data of the disparity information image of the non-base view.

Specifically, the non-base view decoding unit 223 is configured to include a SPS decoding unit 251, a PPS decoding unit 252, a SEI decoding unit 253, a slice header decoding unit 254, and a slice data decoding unit 255.

The SPS decoding unit 251 extracts the SPS of the non-base view from the encoded data of the non-base view, decodes the SPS, and supplies the encoded data and the decoded SPS to the PPS decoding unit 252. Moreover, the SPS decoding unit 251 supplies, to the slice header decoding unit 254, the flags necessary to generate a slice header of the non-base view within the SPS.

The PPS decoding unit 252 extracts the PPS of the non-base view from the encoded data of the non-base view, decodes the PPS, and supplies the encoded data and the decoded SPS and PPS to the SEI decoding unit 253. Moreover, the PPS decoding unit 252 supplies, to the slice header decoding unit 254, the flag necessary to generate a slice header of the non-base view within the PPS.

The SEI decoding unit 253 extracts the SEI of the non-base view from the encoded data of the non-base view, decodes the SEI, and supplies the encoded data and the decoded SPS, PPS, and SEI to the slice header decoding unit 254.

The slice header decoding unit 254 extracts the slice header from the encoded data of the non-base view, decodes the slice header, and supplies the encoded data and the decoded SPS, PPS, SEI, and slice header to the slice data decoding unit 255. In this case, the slice header decoding unit 254 copies the shared part from the slice header of the base view decoded by the slice header decoding unit 234 of the base view decoding unit 222, in accordance with the dependent slice flag of the slice header. Moreover, the slice header decoding unit 254 refers to the flags of the SPS from the SPS decoding unit 251 and the flag of the PPS from the PPS decoding unit 252, and extracts and decodes the slice header information.

The slice data decoding unit 255 is composed of a decoder 261 and a decoder 262. The slice data decoding unit 255 decodes the encoded data of the non-base view based on the SPS, PPS, SEI, slice header, and the like from the slice header decoding unit 254, and generates a non-base view image being the slice data of the non-base view.

In other words, the decoder 261 decodes the encoded data of the non-base view based on the SPS, PPS, SEI, slice header, and the like from the slice header decoding unit 254, and generates a color image of the non-base view. The decoder 262 decodes the encoded data of the non-base view based on the SPS, PPS, SEI, slice header, and the like from the slice header decoding unit 254, and generates a disparity information image of the non-base view. The decoders 261 and 262 select a reference picture to refer to for decoding a decoding target image from the decoded images of the base view or non-base view stored in the DPB 224, to decode the image using the reference picture. In this case, the decoded image as a result of decoding is temporarily stored in the DPB 224.

The DPB 224 temporarily stores images after decoding (decoded images) obtained by decoding to decode target images to be decoded respectively by the decoders 241, 242, 261, and 262, as (candidates for) the reference picture to be referred to upon generation of a prediction image.

The DPB 224 is shared between the decoders 241, 242, 261, and 262. Accordingly, each of the decoders 241, 242, 261, and 262 can also refer to the decoded image obtained by another encoder, in addition to the decoded image obtained by itself. However, the decoders 241 and 242, which encode the base view image, can refer to only images from the same view (base view).

### Configuration Example of Decoder

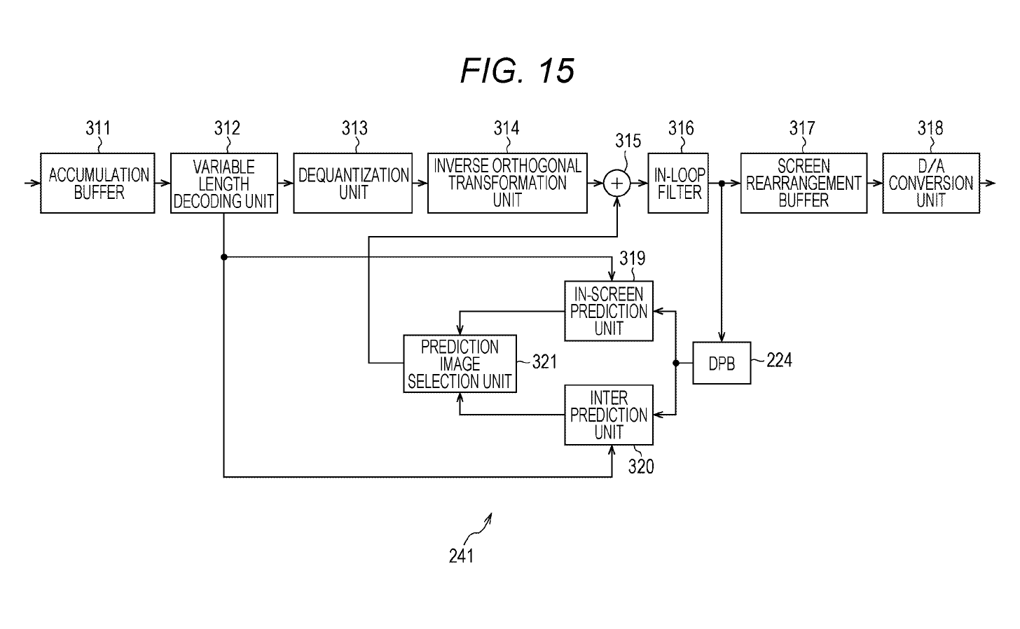

FIG. 15 is a block diagram illustrating a configuration example of the decoder 241. The decoders 242, 261, and 262 are also configured similarly to the decoder 241.

In the example of FIG. 15, the decoder 241 includes an accumulation buffer 311, a variable length decoding unit 312, an dequantization unit 313, an inverse orthogonal transformation unit 314, a computing unit 315, an in-loop filter 316, a screen rearrangement buffer 317, a D/A (Digital/Analog) conversion unit 318, an in-screen prediction unit 319, an inter prediction unit 320, and a prediction image selection unit 321.

The receiving unit 221 (FIG. 14) supplies the encoded data of the color image of the base view to the accumulation buffer 311.

The encoded data supplied to the accumulation buffer 311 is temporarily stored therein. The accumulation buffer 311 supplies the encoded data to the variable length decoding unit 312.

The variable length decoding unit 312 performs variable-length decoding of the encoded data from the accumulation buffer 311, and restores the quantized value and the header information. The variable length decoding unit 312 supplies the quantized value to the dequantization unit 313, and supplies the header information to the in-screen prediction unit 319 and the inter prediction unit 320.

The dequantization unit 313 dequantizes the quantized value from the variable length decoding unit 312 into a transform coefficient and supplies the transform coefficient to the inverse orthogonal transformation unit 314.

The inverse orthogonal transformation unit 314 performs an inverse orthogonal transformation on the transform coefficient from the dequantization unit 313, and supplies the data on a macroblock basis to the computing unit 315.

The computing unit 315 sets the macroblock supplied from the inverse orthogonal transformation unit 314 as a target block of a decoding target, adds the prediction image supplied from the prediction image selection unit 321 to the target block, as necessary, and accordingly performs decoding. The computing unit 315 supplies the resultant decoded image to the in-loop filter 316.

The in-loop filter 316 is composed of, for example, a deblocking filter. For example, if the HEVC format is adopted, the in-loop filter 316 is composed of a deblocking filter and a sample adaptive offset filter. The in-loop filter 316 filters the decoded image from the computing unit 315 as in, for example, the in-loop filter 121 of FIG. 2, and supplies the filtered decoded image to the screen rearrangement buffer 317.

The screen rearrangement buffer 317 temporarily stores and reads the pictures of the decoded image from the in-loop filter 316, and accordingly makes a rearrangement of the pictures to the original arrangement (display order), and supplies the pictures to the D/A conversion unit 318.

If there is a need to output the pictures from the screen rearrangement buffer 317 in an analog signal, the D/A conversion unit 318 D/A converts and outputs the pictures.

Moreover, the in-loop filter 316 supplies, to the DPB 224, the decoded images of the I pictures, P pictures, and Bs pictures being referable pictures within the filtered decoded image.

Here, the DPB 224 stores the pictures of the decoded image from the in-loop filter 316, in other words, the pictures of the color image of the base view as candidates for the reference picture (candidate pictures) to be referred to upon generation of a prediction image used for decoding to be performed temporally later.

As described in FIG. 14, the DPB 224 is shared between the decoders 241, 242, 261, and 262. Accordingly, in addition to the pictures of the color image of the base view decoded in the decoder 241, the pictures of the color image of the non-base view decoded in the decoder 261, the pictures of the disparity information image of the base view decoded in the decoder 242, and the pictures of the disparity information image of the non-base view decoded in the decoder 262 are also stored.

The in-screen prediction unit 319 recognizes whether or not the target block has been encoded using the prediction image generated by intra prediction (in-screen prediction) based on the header information from the variable length decoding unit 312.

If the target block has been encoded using the prediction image generated by intra prediction, the in-screen prediction unit 319 reads, from the DPB 224, an already decoded part (decoded image) of the picture (target picture) including the target block, as in the in-screen prediction unit 122 of FIG. 2. The in-screen prediction unit 319 then sets a part of the decoded image, read from the DPB 224, of the target picture as the prediction image of the target block and supplies the part of the decoded image to the prediction image selection unit 321.

The inter prediction unit 320 recognizes whether or not the target block has been encoded using the prediction image generated by inter prediction, based on the header information from the variable length decoding unit 312.

If the target block has been encoded using the prediction image generated by inter prediction, the inter prediction unit 320 recognizes an optimum inter prediction mode of the target block based on the header information from the variable length decoding unit 312, and reads a candidate picture corresponding to the optimum inter prediction mode as the reference picture from the candidate pictures stored in the DPB 224.

Furthermore, the inter prediction unit 320 recognizes a displacement vector indicating the motion used to generate the prediction image of the target block, based on the header information from the variable length decoding unit 312, performs motion compensation on the reference picture in accordance with the displacement vector as in the inter prediction unit 123 of FIG. 2, and accordingly generates a prediction image.

In other words, the inter prediction unit 320 acquires, as the prediction image, the block (corresponding block) of the candidate picture at a position moved (displaced) from the position of the target block in accordance with the displacement vector of the target block.

The inter prediction unit 320 then supplies the prediction image to the prediction image selection unit 321.

If being supplied with a prediction image from the in-screen prediction unit 319, the prediction image selection unit 321 selects the prediction image from the in-screen prediction unit 319. If being supplied with a prediction image from the inter prediction unit 320, the prediction image selection unit 321 selects the prediction image from the inter prediction unit 320. Accordingly, the prediction image selection unit 321 supplies the prediction image to the computing unit 315.

### Operation of Multiview Image Decoding Apparatus

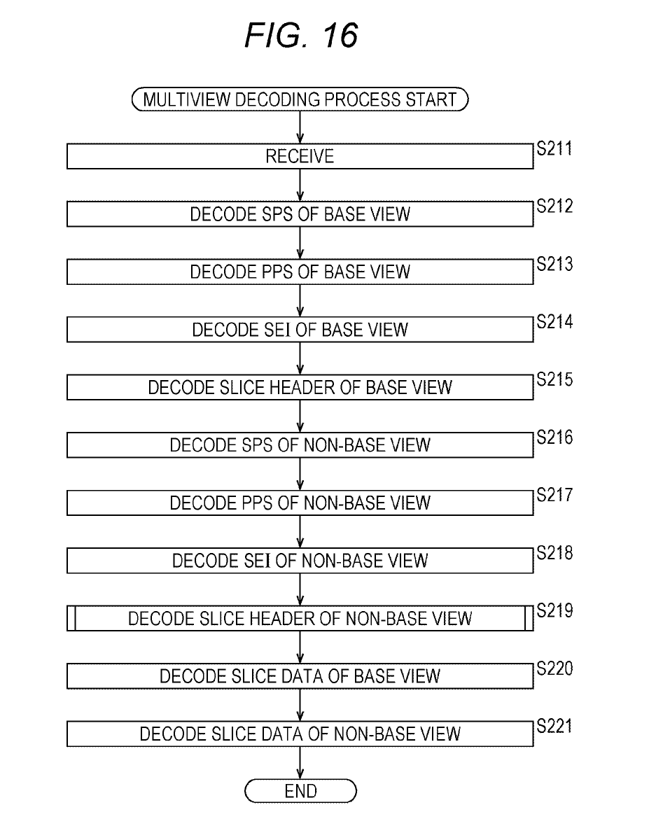

Next, a description is given for a multiview image decoding process as the operation of the multiview image decoding apparatus 211 of FIG. 14 with reference to a flowchart of FIG. 16.

In Step S211, the receiving unit 221 receives the encoded stream transmitted from the multiview image encoding apparatus 11 of FIG. 1. The receiving unit 221 separates, from the received bitstream, the encoded data of the color image of the base view, the encoded data of the disparity information image of the base view, the encoded data of the color image of the non-base view, and the encoded data of the disparity information image of the non-base view.

The receiving unit 221 then supplies, to the base view decoding unit 222, the encoded data of the color image of the base view and the encoded data of the disparity information image of the base view. The receiving unit 221 supplies, to the non-base view decoding unit 223, the encoded data of the color image of the non-base view and the encoded data of the disparity information image of the non-base view.

In Step S212, the SPS decoding unit 231 extracts the SPS of the base view from the encoded data of the base view, decodes the SPS, and supplies the encoded data and the decoded SPS to the PPS decoding unit 232.

In Step S213, the PPS decoding unit 232 extracts the PPS of the base view from the encoded data of the base view, decodes the PPS, and supplies the encoded data and the decoded SPS and PPS to the SEI decoding unit 233.

In Step S214, the SEI decoding unit 233 extracts the SEI of the base view from the encoded data of the base view, decodes the SEI, and supplies the encoded data and the decoded SPS, PPS, and SEI to the slice header decoding unit 234.

In Step S215, the slice header decoding unit 234 extracts the slice header from the encoded data of the base view, decodes the slice header, and supplies the encoded data and the decoded SPS, PPS, SEI, and slice header to the slice data decoding unit 235.

On the other hand, in Step S216, the SPS decoding unit 251 extracts the SPS of the non-base view from the encoded data of the non-base view, decodes the SPS, and supplies the encoded data and the decoded SPS to the PPS decoding unit 252.

At the same time, the SPS decoding unit 251 supplies, to the slice header decoding unit 254, flags necessary to generate a slice header of the non-base view within the SPS. Specifically, the flag for the Long-term picture index and the flag for Reference picture list modification in the SPS extension of FIG. 7 are supplied to the slice header decoding unit 254.

In Step S217, the PPS decoding unit 252 extracts the PPS of the non-base view from the encoded data of the non-base view, decodes the PPS, and supplies the encoded data and the decoded SPS and PPS to the SEI decoding unit 233.

At the same time, the PPS decoding unit 252 supplies, to the slice header decoding unit 254, a flag necessary to generate the slice header of the non-base view within the PPS. Specifically, the flag for Weighted prediction in the PPS extension of FIG. 8 is supplied to the slice header decoding unit 254.

In Step S218, the SEI decoding unit 253 extracts the SEI of the non-base view from the encoded data of the non-base view, decodes the SEI, and supplies the encoded data and the decoded SPS, PPS, and SEI to the slice header decoding unit 254.

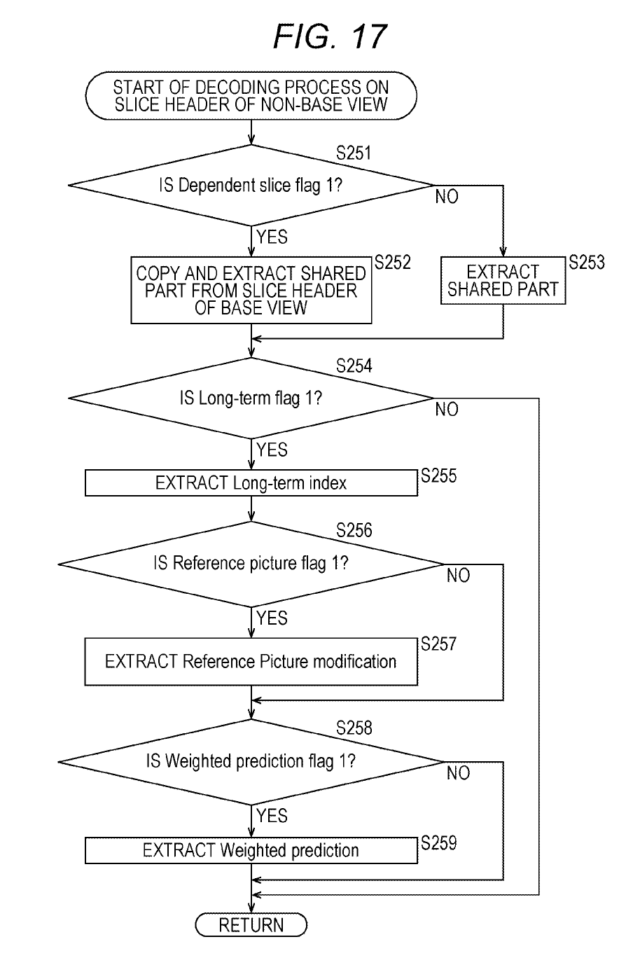

In Step S219, the slice header decoding unit 254 extracts the slice header from the encoded data of the non-base view, and decodes the slice header. The decoding process of the slice header of the non-base view is described later with reference to FIG. 17.

In Step S219, the shared part is copied from the slice header of the base view decoded by the slice header decoding unit 234 in accordance with the dependent slice flag of the slice header. Moreover, the flags of the SPS from the SPS decoding unit 251 and the flag of the PPS from the PPS decoding unit 252 are referred to, and the slice header information is extracted and decoded. The encoded data and the decoded SPS, PPS, SEI, and slice header are supplied to the slice data decoding unit 255.

In Step S220, the slice data decoding unit 235 decodes the encoded data of the base view based on the SPS, PPS, SEI, slice header, and the like from the slice header decoding unit 234, and generates a base view image being the slice data of the base view.

In Step S221, the slice data decoding unit 255 decodes the encoded data of the non-base view based on the SPS, PPS, SEI, slice header, and the like from the slice header decoding unit 254, and generates a base view image being the slice data of the non-base view.

As described above, in the slice header of the non-base view, the inter-view prediction syntaxes (parameters) are configured to be collectively placed. Consequently, the dependent slice can be used. If the flag is set, the shared part can be copied on the decoding side. As a result, the amount of encoding of the slice header in the non-base view can be reduced.

### Example of Slice Header Decoding Process of Non-Base View

Next, a description is given for the slice header encoding process of the non-base view of Step S18 of FIG. 12 with reference to a flowchart of FIG. 17.

In Step S251, the slice header decoding unit 254 extracts the slice header from the encoded data, and determines whether or not the dependent slice flag is 1.

If it is determined that the dependent slice flag is 1 in Step S251, the execution proceeds to Step S252. In Step S252, the slice header decoding unit 254 copies and extracts the shared part of the slice header from the slice header of the base view.

If it is determined that the dependent slice flag is 0 in Step S251, the execution proceeds to Step S253. In Step S253, the slice header decoding unit 254 extracts the shared part of the slice header from the slice header acquired from the encoded data of the non-base view.

In Step S254, the slice header decoding unit 254 determines whether or not the Long-term flag (the flag for the Long-term picture index) in the SPS extension supplied in Step S216 of FIG. 16 is 1.

If it is determined that the Long-term flag is 1 in Step S254, the execution proceeds to Step S255. In Step S255, the slice header decoding unit 254 extracts the Long-term picture index from the slice header extension. Therefore, the Long-term picture index of the shared part of the slice header is used for inter prediction. The parameter of the Long-term picture index is used for inter-view prediction.

If it is determined that the Long-term flag is 0 in Step S254, the processing from Steps S255 to S259 is skipped, and the decoding process ends. In other words, if the Long-term flag is 0, inter-view prediction is not used. Accordingly, both the Reference picture flag and the Weighted prediction flag become 0.

In Step S256, the slice header decoding unit 254 determines whether or not the Reference picture flag (the flag for Reference picture list modification) in the SPS extension supplied in Step S216 of FIG. 16 is 1.

If it is determined that the Reference picture flag is 1 in Step S256, the execution proceeds to Step S257. In Step S257, the slice header decoding unit 254 extracts Reference picture list modification from the slice header extension. Therefore, the parameter of Reference picture list modification is used for inter prediction even if the description of Reference picture list modification is present in the shared part of the slice header.

If it is determined that the Reference picture flag is 0 in Step S256, the processing of Step S257 is skipped and the execution proceeds to Step S258.

In Step S258, the slice header decoding unit 254 determines whether or not the Weighted prediction flag (the flag for Weighted prediction) in the PPS extension supplied in Step S217 of FIG. 16 is 1.

If it is determined that the Weighted prediction flag is 1 in Step S258, the execution proceeds to Step S259. In Step S259, the slice header decoding unit 254 extracts Weighted prediction from the slice header extension. Therefore, the parameter of Weighted prediction is used even if the description of Weighted prediction is present in the shared part of the slice header.

If it is determined that the Weighted prediction flag is 0 in Step S258, the processing of Step S259 is skipped.

As described above, the slice header of the non-base view is decoded. The execution returns to Step S219 of FIG. 16, and proceeds to Step S220.

As described above, it is configured in the non-base view such that the inter-view prediction parameters used for inter-view prediction, which are difficult to be shared with the base view, are collectively placed. Accordingly, it is possible to reduce the amount of encoding of the slice header, using the dependent slice.

The description has been given of the example of the above-mentioned inter-view prediction parameters where parameters are described in an extension provided at a different position from the header and, if the flag is set, the parameter described in the extension is overwritten. However, the parameter is not limited to the inter-view prediction parameter. This can also be applied to another parameter.

It can also be applied to, for example, the parameters of the Header parameter Set (HPS) described in Patent Document 2.

### 3. Third Embodiment

### Summary of HPS

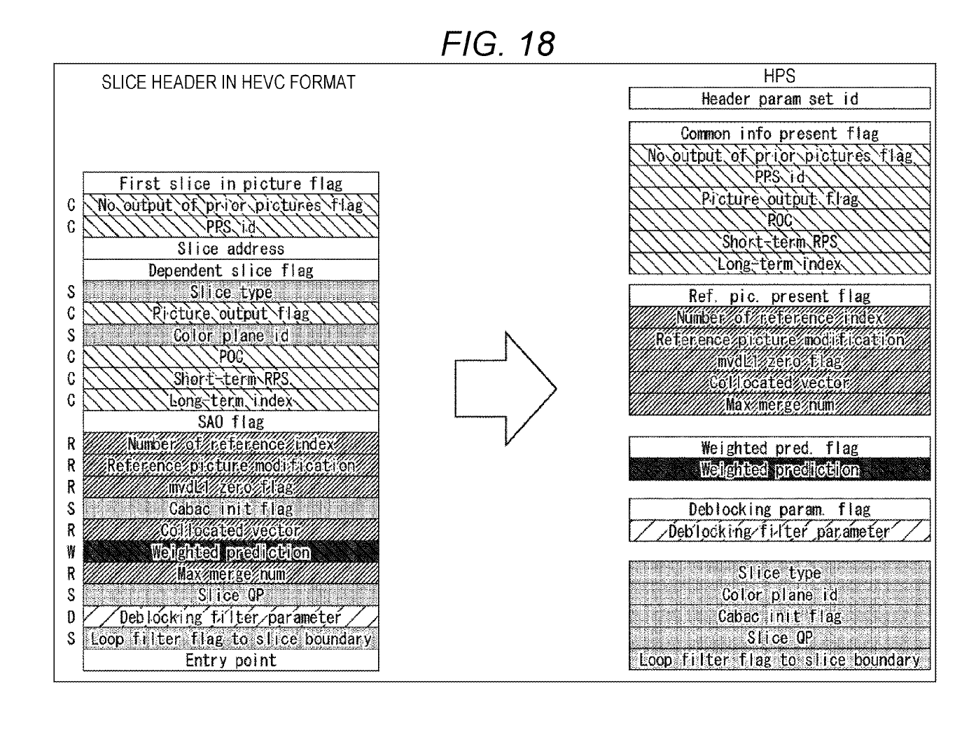

Next, the HPS is described with reference to FIG. 18. The example of FIG. 18 illustrates the abbreviated slice header in the HEVC format on the left side, and illustrates the abbreviated slice header in the case of the HPS on the right side.

Parameters assigned at the left with C in the slice header in the HEVC format are grouped and flagged as Common info present flag in the slice header of the HPS. Parameters assigned at the left with R in the slice header in the HEVC format are grouped and flagged as Ref.pic.present flag in the slice header of the HPS. Parameters assigned at the left with W in the slice header in the HEVC format are grouped and flagged as Weighted pred. flag in the slice header of the HPS. Parameters assigned at the left with D in the slice header in the HEVC format are grouped and flagged as Deblocking param. flag in the slice header of the HPS.

Parameters assigned at the left with S in the slice header in the HEVC format are grouped in the rear of the slice header in the slice header of the HPS.

If each flag has been set in the HPS, then the grouped parameters corresponding to the flag are shared (in other words, they are copied and used on the decoding side). Consequently, the amount of encoding of the slice header can be reduced.

For example, also in the header of such an HPS, if a flag is set and a redefinition is given in an extension part, the description in the header may be overwritten with a parameter described in the extension.

In the above description, the example of two views of the base view and the non-base view has been described. However, the present technology is not limited to the two views and can also be applied to the encoding and decoding of a multiview image other than the two views.

In the above description, the HEVC format is used for a base as the encoding format. However, the present disclosure is not limited to this, and any other encoding/decoding format can be applied.

The present disclosure can be applied to, for example, an image encoding apparatus and an image decoding apparatus that are used for receiving image information (a bitstream) compressed by an orthogonal transformation such as a discrete cosign transform, and motion compensation via a network medium such as satellite broadcasting, a cable television, the Internet, or a mobile phone device, as in the HEVC format or the like. Moreover, the present disclosure can be applied to an image encoding apparatus and an image decoding apparatus that are used for processing on a storage medium such as an optical or magnetic disc, or flash memory.

### 4. Fourth Embodiment

### Configuration Example of Computer

The above-mentioned series of processes can be executed by hardware and can also be executed by software. If the series of processes is executed by software, a program configuring the software is installed in a computer. Here, examples of the computer include a computer built in dedicated hardware, and a general-purpose computer capable of executing various functions by installing various programs.

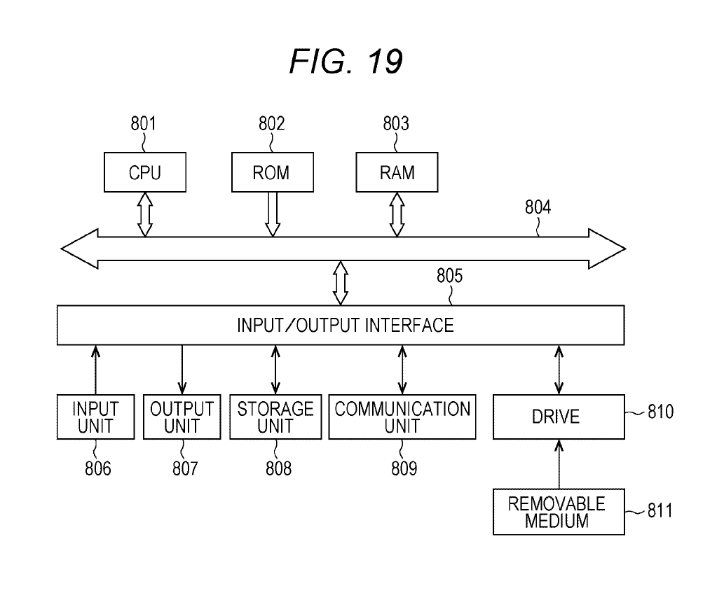

FIG. 19 is a block diagram illustrating a configuration example of hardware of a computer that executes the above-mentioned series of processes by a program.

In a computer 800, a CPU (Central Processing Unit) 801, a ROM (Read Only Memory) 802, a RAM (Random. Access Memory) 803 are mutually connected by a bus 804.

The bus 804 is further connected to an input/output interface 805. The input/output interface 805 is connected to an input unit 806, an output unit 807, a storage unit 808, a communication unit 809, and a drive 810.

The input unit 806 includes a keyboard, a mouse, and a microphone. The output unit 807 includes a display and a speaker. The storage unit 808 includes a hard disk or a nonvolatile memory. The communication unit 809 includes a network interface. The drive 810 drives a removable medium 811 such as a magnetic disk, optical disc, magneto-optical disk, or semiconductor memory.

In the computer configured as described above, the CPU 801 loads, for example, a program stored in the storage unit 808 to the RAM 803 via the input/output interface 805 and the bus 804, and executes the program. Accordingly, the above-mentioned series of processes is performed.

The program to be executed by the computer 800 (the CPU 801) can be, for example, recorded and provided in the removable medium 811 as packaged media. Moreover, the program can be provided via a wired or wireless transmission medium such as a local area network, the Internet, or digital satellite broadcasting.

In the computer, the program can be installed in the storage unit 808 via the input/output interface 805 by mounting the removable medium 811 in the drive 810. Moreover, the program can be received by the communication unit 809 via a wired or wireless transmission medium and installed in the storage unit 808. In addition, the program can be installed in advance in the ROM 802 or the storage unit 808.

The program to be executed by the computer may be a program where the processes are performed in chronological order along the sequence described in the specification, or may be a program where the processes are performed in parallel or at necessary timings such as when a call is issued.

Moreover, in the specification, the step of describing the program to be recorded in the recording medium includes, naturally, processes to be performed in chronological order along the described sequence, and also processes to be executed in parallel or individually even if they are not necessarily performed in chronological order.

Moreover, in the specification, a system indicates the entire apparatus configured by a plurality of devices (devices).

Moreover, the configuration described above as one device (or processing unit) may be configured to be divided into a plurality of devices (or processing units). Conversely, the configurations described above as a plurality of devices (or processing units) may be configured to be integrated as one device (or processing unit). Moreover, naturally, a configuration other than the above-mentioned configurations may be configured to be added to the configuration of each device (or processing unit). Furthermore, as long as the configuration and operation as the entire system are substantially the same, a part of the configuration of a certain device (or processing unit) may be configured to be included in the configuration of another device (or another processing unit). In other words, the present technology is not limited to the above-mentioned embodiments. Various alterations can be made within the scope that does not depart from the gist of the present technology.

The image encoding apparatus and the image decoding apparatus according to the above-mentioned embodiments can be applied to various electronic devices such as transmitters and receivers in, for example, distribution on satellite broadcasting, wired broadcasting such as a cable TV, and the Internet, and distribution to a terminal by cellular communications, recording devices that record images in media such as optical discs, magnetic disks, or flash memories, and playback devices that play back the images from these storage media. Hereinafter, four application examples are described.

### 5. Application Examples

### First Application Example

### Television Receiver

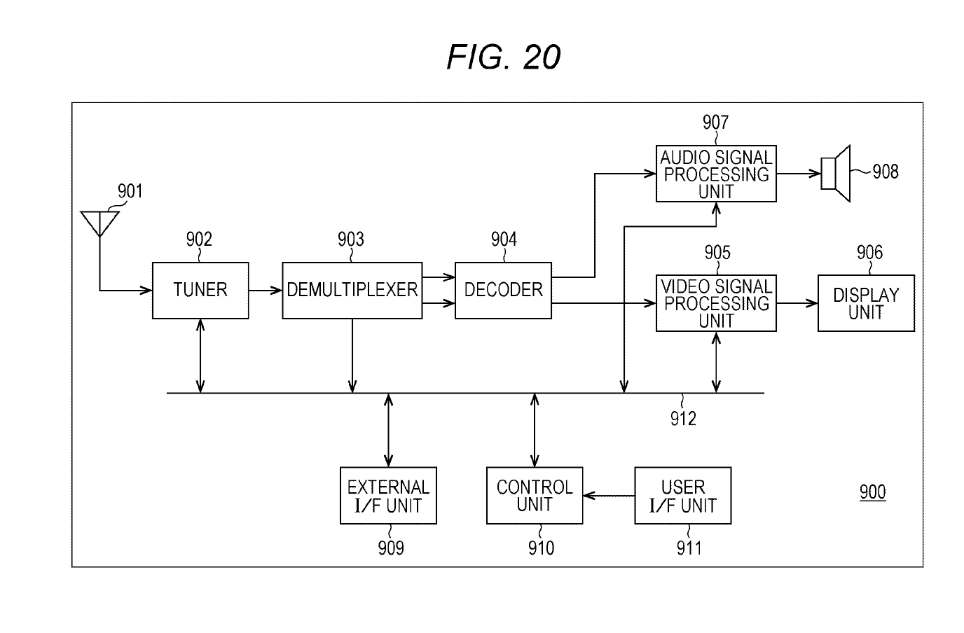

FIG. 20 illustrates an example of a schematic configuration of a television apparatus to which the above-mentioned embodiments have been applied. A television apparatus 900 includes an antenna 901, a tuner 902, a demultiplexer 903, a decoder 904, a video signal processing unit 905, a display unit 906, an audio signal processing unit 907, a speaker 908, an external interface 909, a control unit 910, a user interface 911, and a bus 912.

The tuner 902 extracts a desired channel signal from a broadcast signal received via the antenna 901, and decodes the extracted signal. The tuner 902 then outputs the encoded bitstream obtained by decoding to the demultiplexer 903. In other words, the tuner 902 acts as transmission means in the television apparatus 900, the transmission means receiving an encoded stream in which an image has been encoded.

The demultiplexer 903 separates a video stream and an audio stream of a viewing target program from the encoded bitstream, and outputs the separated steams to the decoder 904. Moreover, the demultiplexer 903 extracts supplemental data such as an EPG (Electronic Program Guide) from the encoded bitstream, and supplies the extracted data to the control unit 910. The demultiplexer 903 may perform descrambling if the encoded bitstream has been scrambled.

The decoder 904 decodes the video and audio streams input from the demultiplexer 903. The decoder 904 then outputs the video data generated by the decoding process to the video signal processing unit 905. Moreover, the decoder 904 outputs the audio data generated by the decoding process to the audio signal processing unit 907.

The video signal processing unit 905 plays back the video data input from the decoder 904 and displays the video on the display unit 906. Moreover, the video signal processing unit 905 may display an application screen supplied via a network on the display unit 906. Moreover, the video signal processing unit 905 may perform an additional process such as noise removal (suppression) on the video data in accordance with the setting. Furthermore, the video signal processing unit 905 may generate an image of a GUI (Graphical User Interface) such as a menu, button or cursor, and superimpose the generated image on an output image.

The display unit 906 is driven by a drive signal supplied from the video signal processing unit 905, and displays a video or image on a video plane of a display device (for example, a liquid crystal display, plasma display, or OELD (Organic ElectroLuminescence Display) (organic EL display)).

The audio signal processing unit 907 performs playback processes such as D/A conversion and amplification on the audio data input from the decoder 904, and outputs the audio from the speaker 908. Moreover, the audio signal processing unit 907 may perform an additional process such as noise removal (suppression) on the audio data.

The external interface 909 is an interface for connecting the television apparatus 900 and an external device or network. For example, a video stream or audio stream received via the external interface 909 may be decoded by the decoder 904. In other words, the external interface 909 also acts as the transmission means in the television apparatus 900, the transmission means receiving an encoded stream in which an image has been encoded.

The control unit 910 includes a processor such as a CPU and memories such as a RAM and a ROM. A program to be executed by the CPU, program data, EPG data, data to be acquired via a network, and the like are stored in the memory. The program to be stored in the memory is read and executed by the CPU, for example, at the start of the television apparatus 900. The CPU executes the program and accordingly controls the operation of the television apparatus 900 in response to, for example, an operation signal to be input from the user interface 911.

The user interface 911 is connected to the control unit 910. The user interface 911 includes, for example, a button and switch for allowing a user to operate the television apparatus 900, and a receiving unit of a remote control signal. The user interface 911 detects an operation by a user via these components, generates an operation signal, and outputs the generated operation signal to the control unit 910.

The bus 912 mutually connects the tuner 902, the demultiplexer 903, the decoder 904, the video signal processing unit 905, the audio signal processing unit 907, the external interface 909, and the control unit 910.

In the television apparatus 900 configured as described above, the decoder 904 has the function of the image decoding apparatus according to the above-mentioned embodiment. Consequently, when an image is decoded in the television apparatus 900, the amount of encoding of the slice header of the non-base view can be reduced.

### Second Application Example

### Mobile Phone Device

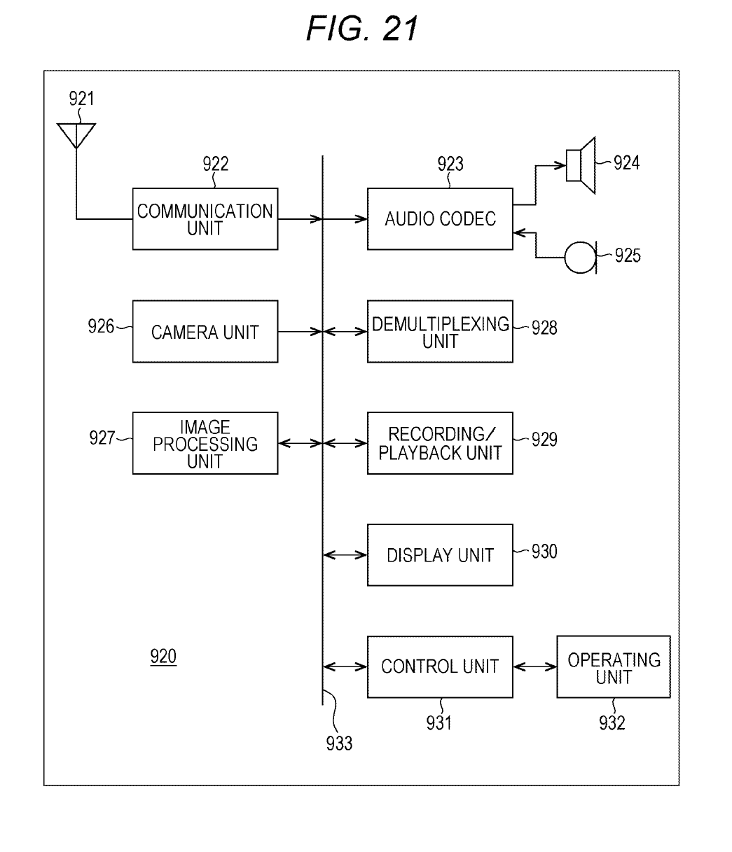

FIG. 21 illustrates an example of a schematic configuration of a mobile phone device to which the above-mentioned embodiments have been applied. A mobile phone device 920 includes an antenna 921, a communication unit 922, an audio codec 923, a speaker 924, a microphone 925, a camera unit 926, an image processing unit 927, a demultiplexing unit 928, a recording/playback unit 929, a display unit 930, a control unit 931, an operating unit 932, and a bus 933.

The antenna 921 is connected to the communication unit 922. The speaker 924 and the microphone 925 are connected to the audio codec 923. The operating unit 932 is connected to the control unit 931. The bus 933 mutually connects the communication unit 922, the audio codec 923, the camera unit 926, the image processing unit 927, the demultiplexing unit 928, the recording/playback unit 929, the display unit 930, and the control unit 931.

The mobile phone device 920 performs operations such as the transmission/reception of an audio signal, the transmission/reception of an electronic mail or image data, the capture of an image, and the recording of data in various operating modes including a voice call mode, a data communication mode, a shooting mode, and a videophone mode.

In voice call mode, an analog audio signal generated by the microphone 925 is supplied to the audio codec 923. The audio codec 923 converts the analog audio signal into audio data, and A/D converts and compresses the converted audio data. The audio codec 923 then outputs the compressed audio data to the communication unit 922. The communication unit 922 encodes and modulates the audio data, and generates a transmission signal. The communication unit 922 then transmits the generated transmission signal to a base station (not illustrated) via the antenna 921. Moreover, the communication unit 922 amplifies a wireless signal received via the antenna 921, converts its frequency, and acquires the received signal. The communication unit 922 then demodulates and decodes the received signal, generates audio data, and outputs the generated audio data to the audio codec 923. The audio codec 923 decompresses and D/A converts the audio data, and generates an analog audio signal. The audio codec 923 then supplies the generated audio signal to the speaker 924 to output the voice.

Moreover, in data communication mode, for example, the control unit 931 generates character data forming an electronic mail in response to an operation by a user via the operating unit 932. Moreover, the control unit 931 displays characters on the display unit 930. Moreover, the control unit 931 generates electronic mail data and outputs the generated electronic mail data to the communication unit 922 in response to a transmission instruction from the user via the operating unit 932. The communication unit 922 encodes and modulates the electronic mail data, and generates a transmission signal. The communication unit 922 then transmits the generated transmission signal to a base station (not illustrated) via the antenna 921. Moreover, the communication unit 922 amplifies a wireless signal received via the antenna 921, converts its frequency, and acquires the received signal. The communication unit 922 then demodulates and decodes the received signal, restores the electronic mail data, and outputs the restored electronic mail data to the control unit 931. The control unit 931 displays the content of the electronic mail on the display unit 930 and also stores the electronic mail data in a storage medium of the recording/playback unit 929.

The recording/playback unit 929 includes an arbitrary readable/writable storage medium. For example, the storage medium may be an integrated storage medium such as a RAM or flash memory, or may be an external mounting storage medium such as a hard disk, magnetic desk, magneto-optical disk, optical disc, USB (Universal Serial Bus) memory, or memory card.

Moreover, in shooting mode, for example, the camera unit 926 captures a subject, generates image data, and outputs the generated image data to the image processing unit 927. The image processing unit 927 encodes the image data input from the camera unit 926, and stores the encoded stream in the storage medium of the storage/playback unit 929.

Moreover, in videophone mode, for example, the demultiplexing unit 928 multiplexes the video stream encoded by the image processing unit 927, and the audio stream input from the audio codec 923, and outputs the multiplexed stream to the communication unit 922. The communication unit 922 encodes and modulates the stream, and generates a transmission signal. The communication unit 922 then transmits the generated transmission signal to a base station (not illustrated) via the antenna 921. Moreover, the communication unit 922 amplifies a wireless signal received via the antenna 921, converts its frequency, and acquires the received signal. These transmission and received signals can include an encoded bitstream. The communication unit 922 then demodulates and decodes the received signal, restores the stream, and outputs the restored stream to the demultiplexing unit 928. The demultiplexing unit 928 separates the video and audio streams from the input stream, and outputs the video stream to the image processing unit 927 and the audio stream to the audio codec 923. The image processing unit 927 decodes the video stream and generates video data. The video data is supplied to the display unit 930. The display unit 930 displays a series of images. The audio codec 923 extends and D/A converts the audio stream, and generates an analog audio signal. The audio codec 923 then supplies the generated audio signal to the speaker 924 to output the voice.

In the mobile phone device 920 configured as described above, the image processing unit 927 has the functions of the image encoding apparatus and the image decoding apparatus according to the above-mentioned embodiments. Consequently, when an image is encoded and decoded in the mobile phone device 920, the amount of encoding of the slice header of the non-base view can be reduced.

### Third Application Example

### Recording/Playback Apparatus

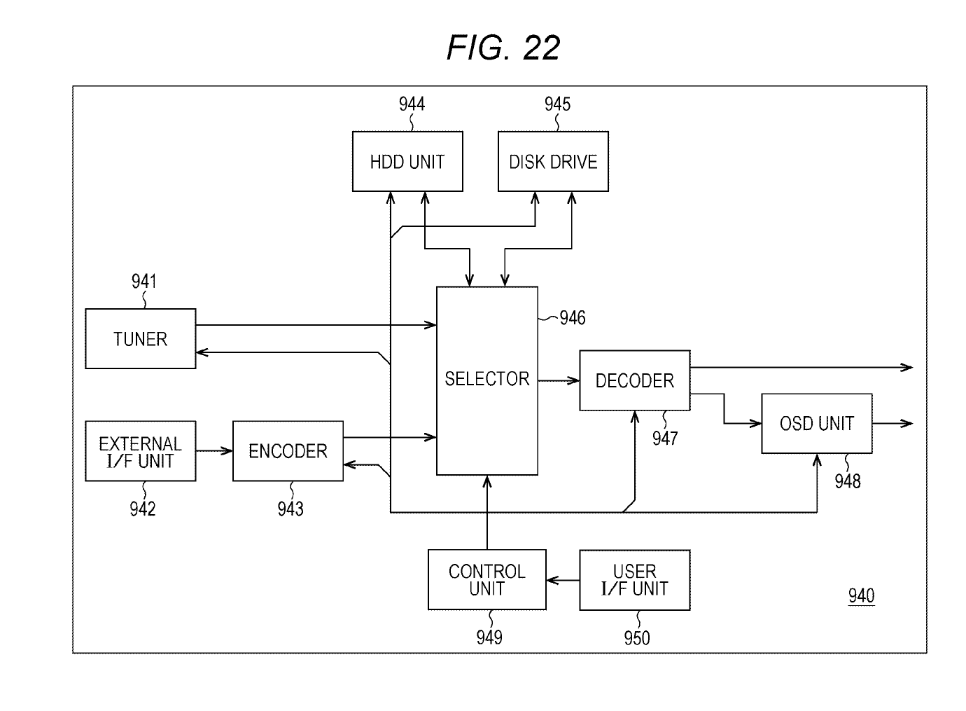

FIG. 22 illustrates an example of a schematic configuration of a recording/playback apparatus to which the above-mentioned embodiments have been applied. A recording/playback apparatus 940 encodes, for example, audio and video data of a received broadcast program and records the data in a recording medium. Moreover, the recording/playback apparatus 940 may encode, for example, audio and video data acquired from another apparatus, and record the data in a recording medium. Moreover, the recording/playback apparatus 940 plays back the data recorded in the recording medium on a monitor and a speaker, in response to, for example, a user's instruction. At the same time, the recording/playback apparatus 940 decodes the audio and video data.

The recording/playback apparatus 940 includes a tuner 941, an external interface 942, an encoder 943, an HDD (Hard Disk Drive) 944, a disk drive 945, a selector 946, a decoder 947, an OSD (On-Screen Display) 948, a control unit 949, and a user interface 950.

The tuner 941 extracts a desired channel signal from a broadcast signal received via an antenna (not illustrated), and demodulates the extracted signal. The tuner 941 then outputs, to the selector 946, the encoded bitstream obtained by demodulation. In other words, the tuner 941 acts as transmission means in the recording/playback apparatus 940.

The external interface 942 is an interface for connecting the recording/playback apparatus 940 and an external device or network. The external interface 942 may be, for example, an IEEE1394 interface, network interface, USB interface, or flash memory interface. For example, video and audio data received via the external interface 942 is input into the encoder 943. In other words, the external interface 942 acts as transmission means in the recording/playback apparatus 940.

If the video and audio data input from the external interface 942 has not been encoded, the encoder 943 encodes the video and audio data. The encoder 943 then outputs the encoded bitstream to the selector 946.

The HDD 944 records, in an internal hard disk, the encoded bitstream where content data such as a video and audio has been compressed, various programs, and other data. Moreover, the HDD 944 reads these pieces of data from the hard disk upon playback of the video and audio.

The disk drive 945 records and reads data in and from a mounted recording medium. The recording medium mounted in the disk drive 945 may be, for example, a DVD disk (such as DVD-Video, DVD-RAM, DVD-R, DVD-RW, DVD+R, or DVD+RW), or Blu-ray(registered trademark) disk.

Upon recording of a video and audio, the selector 946 selects an encoded bitstream input from the tuner 941 or the encoder 943, and outputs the selected encoded bitstream to the HDD 944 or the disk drive 945. Moreover, upon playback of a video and audio, the selector 946 outputs the encoded bitstream input from the HDD 944 or the disk drive 945 to the decoder 947.

The decoder 947 decodes the decoded bitstream and generates video and audio data. The decoder 947 then outputs the generated video data to the OSD 948. Moreover, the decoder 904 outputs the generated audio data to an external speaker.

The OSD 948 plays back the video data input from the decoder 947 and displays the video. Moreover, the OSD 948 may superimpose an image of a GUI such as a menu, button or cursor on the video to be displayed.

The control unit 949 includes a processor such as a CPU and memories such as a RAM and a ROM. A program to be executed by the CPU, program data, and the like are stored in the memory. The program to be stored in the memory is read and executed by the CPU, for example, at the start of the recording/playback apparatus 940. The CPU executes the program and accordingly controls the operation of the recording/playback apparatus 940 in response to, for example, an operation signal input from the user interface 950.

The user interface 950 is connected to the control unit 949. The user interface 950 includes, for example, a button and switch for allowing a user to operate the recording/playback apparatus 940, and a receiving unit of a remote control signal. The user interface 950 detects an operation by a user via these components, generates an operation signal, and outputs the generated operation signal to the control unit 949.

In the recording/playback apparatus 940 configured as described above, the encoder 943 has the function of the image encoding apparatus according to the above-mentioned embodiment. Moreover, the decoder 947 has the function of the image decoding apparatus according to the above-mentioned embodiment. Consequently, when an image is encoded and decoded in the recording/playback apparatus 940, the amount of encoding of the slice header of the non-base view can be reduced.

### Fourth Application Example

### Imaging Apparatus

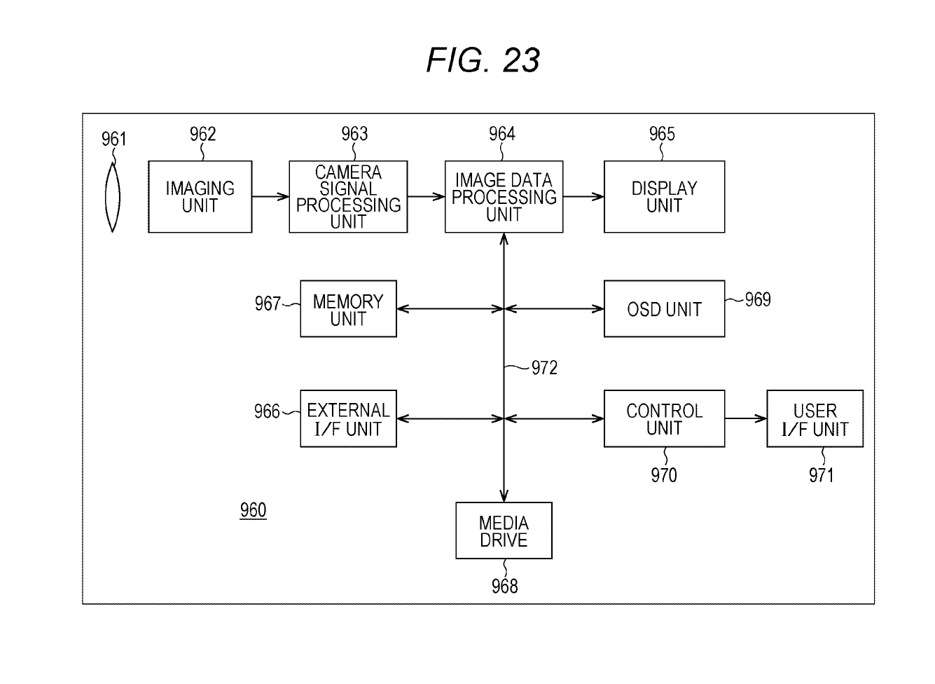

FIG. 23 illustrates an example of a schematic configuration of an imaging apparatus to which the above-mentioned embodiments have been applied. An imaging apparatus 960 captures a subject, generates an image, encodes the image data, and records the image data in a recording medium.

The imaging apparatus 960 includes an optical block 961, an imaging unit 962, a signal processing unit 963, an image processing unit 964, a display unit 965, an external interface 966, a memory 967, a media drive 968, an OSD 969, a control unit 970, a user interface 971, and a bus 972.

The optical block 961 is connected to the imaging unit 962. The imaging unit 962 is connected to the signal processing unit 963. The display unit 965 is connected to the image processing unit 964. The user interface 971 is connected to the control unit 970. The bus 972 mutually connects the image processing unit 964, the external interface 966, the memory 967, the media drive 968, the OSD 969, and the control unit 970.

The optical block 961 includes a focus lens and a diaphragm function. The optical block 961 forms an optical image of the subject on an imaging plane of the imaging unit 962. The imaging unit 962 includes an image sensor such as a CCD (Charge Coupled Device) or CMOS (Complementary Metal Oxide Semiconductor), and converts the optical image formed on the imaging plane into an image signal as an electric signal by photoelectric conversion. The imaging unit 962 then outputs the image signal to the signal processing unit 963.

The signal processing unit 963 performs various camera signal processes such as a knee correction, gamma correction, and color correction on the image signal input from the imaging unit 962. The signal processing unit 963 outputs the image data after the camera signal processes to the image processing unit 964.

The image processing unit 964 encodes the image data input from the signal processing unit 963 and generates encoded data. The image processing unit 964 then outputs the generated encoded data to the external interface 966 or the media drive 968. Moreover, the image processing unit 964 decodes the encoded data input from the external interface 966 or the media drive 968 and generates image data. The image processing unit 964 then outputs the generated image data to the display unit 965. Moreover, the image processing unit 964 may output, to the display unit 965, the image data input from the signal processing unit 963 and display the image. Moreover, the image processing unit 964 may superimpose data for display acquired from the OSD 969 on the image to be output to the display unit 965.

The OSD 969 may generate an image of a GUI such as a menu, button or cursor, and output the generated image to the image processing unit 964.

The external interface 966 is configured as, for example, a USB input/output terminal. The external interface 966 connects the imaging apparatus 960 to a printer upon, for example, printing of the image. Moreover, a drive is connected to the external interface 966 as necessary. For example, a removal medium such as a magnetic disk or optical disc is mounted in the drive. A program read from the removal medium can be installed in the imaging apparatus 960. Furthermore, the external interface 966 may be configured as a network interface to be connected to a network such as a LAN or the Internet. In other words, the external interface 966 acts as transmission means in the imaging apparatus 960.

The recording medium to be mounted in the media drive 968 may be, for example, an arbitrary readable/writable removal medium such as a magnetic disk, magneto-optical disk, optical disc, or semiconductor memory. Moreover, the recording medium is mounted in the media drive 968 in a fixed manner, and a non-portable storage unit such as a built-in hard disk drive or SSD (Solid State Drive) may be configured.

The control unit 970 includes a processor such as a CPU and memories such as a RAM and a ROM. A program to be executed by the CPU, program data, and the like are stored in the memory. The program to be stored in the memory is read and executed by the CPU, for example, at the start of the imaging apparatus 960. The CPU executes the program and accordingly controls the operation of the imaging apparatus 960 in response to, for example, an operation signal input from the user interface 971.

The user interface 971 is connected to the control unit 970. The user interface 971 includes, for example, a button and switch for allowing a user to operate the imaging apparatus 960. The user interface 971 detects an operation by the user via these components, generates an operation signal, and outputs the generated operation signal to the control unit 970.

In the imaging apparatus 960 configured as described above, the image processing unit 964 has the functions of the image encoding apparatus and image decoding apparatus according to the above-mentioned embodiments. Consequently, when an image is encoded and decoded in the imaging apparatus 960, the amount of encoding of the slice header of the non-base view can be reduced.

In the specification, the description has been given of the example where various pieces of information such as the parameter of a deblocking filter and the parameter of a sample adaptive offset filter are multiplexed on an encoded stream, and transmitted from the encoding side to the decoding side. However, the method for transmitting these pieces of information is not limited to such an example. For example, these pieces of information may not be multiplexed on an encoded bitstream and may be transmitted or recorded as another data associated with the encoded bitstream. Here, the term “associate” indicates making it possible to link an image (which may be a part of the image such as a slice or block) contained in the bitstream to information corresponding to the image, upon decoding. In other words, the information may be transmitted in a different transmission path from the image (or bitstream). Moreover, the information may be recorded in a different recording medium (or another recording area of the same recording medium) from the image (or bitstream). Furthermore, the information and the image (or bitstream) may be associated with each other in an arbitrary unit such as a plurality of frames, one frame, or a part of a frame.

As described above, the preferred embodiments of the present disclosure have been described in detail with reference to the accompanying drawings. However, the present disclosure is not limited to such examples. It is obvious that a person with an ordinary skill in the technical field to which the present disclosure pertains can conceive various alterations or modifications within the scope of the technical idea described in the claims, which is also naturally understood to pertain to the technical scope of the present disclosure.

The present technology can also take the following configurations:

(1) An image processing apparatus including a decoding unit that uses inter-view prediction parameters used for inter-view prediction and performs a decoding process on an encoded stream encoded in units having a hierarchy structure in the syntax of the encoded stream where the inter-view prediction parameters are collectively placed.

(2) The image processing apparatus according to the (1), wherein the inter-view prediction parameters are placed as extended data.

(3) The image processing apparatus according to the (1) or (2), wherein the inter-view prediction parameters are placed as the extended data of a slice.

(4) The image processing apparatus according to any of the (1) to (3), wherein the inter-view prediction parameters are placed at positions that are not copied in a slice having a dependent relationship.

(5) The image processing apparatus according to any of the (1) to (4), wherein the inter-view prediction parameters are placed in a different area from a copy destination to which copy is performed in a slice having a dependent relationship.

(6) The image processing apparatus according to any of the (1) to (5), wherein the inter-view prediction parameters are parameters related to inter-view prediction.

(7) The image processing apparatus according to any of the (1) to (6), wherein the inter-view prediction parameter is a parameter that manages a reference relationship in inter-view prediction.

(8) The image processing apparatus according to any of the (1) to (7), wherein the inter-view prediction parameter is a parameter used for weighted prediction in inter-view prediction.

(9) The image processing apparatus according to any of the (1) to (8), wherein the decoding unit performs a decoding process on the inter-view prediction parameters received by the receiving unit, and performs a decoding process on an encoded stream received by the receiving unit, using the inter-view prediction parameters on which the decoding process has been performed.

(10) An image processing method for an image processing apparatus including using inter-view prediction parameters used for inter-view prediction and performing a decoding process on an encoded stream encoded in units having a hierarchy structure in the syntax of the encoded stream where the inter-view prediction parameters are collectively placed.

(11) An image processing apparatus including:

an encoding unit configured to perform an encoding process on image data in units having a hierarchy structure and generating an encoded stream;

a placement unit configured to collectively place inter-view prediction parameters used for inter-view prediction in the syntax of the encoded stream generated by the encoding unit; and

a transmission unit configured to transmit the encoded stream generated by the encoding unit and the inter-view prediction parameters collectively placed by the placement unit.

(12) The image processing apparatus according to the (11), wherein the placement unit places the inter-view prediction parameters as extended data.

(13) The image processing apparatus according to the (11) or (12), wherein the placement unit places the inter-view prediction parameters as the extended data of a slice.

(14) The image processing apparatus according to any of the (11) to (13), wherein placement unit places the inter-view prediction parameters at positions that are not copied in a slice having a dependent relationship.

(15) The image processing apparatus according to any of the (11) to (14), wherein the inter-view prediction parameters are placed in a different area from a copy destination to which copy is performed in a slice having a dependent relationship.

(16) The image processing apparatus according to any of the (11) to (15), wherein the inter-view prediction parameters are parameters related to inter-view prediction.

(17) The image processing apparatus according to any of the (10) to (16), wherein the inter-view prediction parameter is a parameter that manages a reference relationship in inter-view prediction.

(18) The image processing apparatus according to any of the (10) to (17), wherein the inter-view prediction parameter is a parameter used for weighted prediction in inter-view prediction.

(19) The image processing apparatus according to any of the (10) to (18), wherein

the encoding unit performs an encoding process on the inter-view prediction parameters, and

the placement unit collectively places the inter-view prediction parameters on which the encoding process has been performed by the encoding unit.

(20) An image processing method for an image processing apparatus including:

performing an encoding process on image data in units having a hierarchy structure and generating an encoded stream:

collectively placing inter-view prediction parameters used for inter-view prediction in the syntax of the generated encoded stream; and

transmitting the generated encoded stream and the collectively placed inter-view prediction parameters.

### REFERENCE SIGNS LIST

11 Multiview image encoding apparatus
21 Base view encoding unit
22 Non-base view encoding unit
23 Comparison unit
24 DPB
25 Transmission unit
31 SPS encoding unit
32 PPS encoding unit
33 SEI encoding unit
34 Slice header encoding unit
35 Slice data encoding unit
41, 42 Encoder
51 SPS encoding unit
52 PPS encoding unit
53 SEI encoding unit
54 Slice header encoding unit
55 Slice data encoding unit
61, 62 Encoder
211 Multiview image decoding apparatus
221 Receiving unit
222 Base view decoding unit
223 Non-base view decoding unit
224 DPB
231 SPS decoding unit
232 PPS decoding unit
233 SEI decoding unit
234 Slice header decoding unit
235 Slice data decoding unit
241, 242 Encoder
251 SPS decoding unit
252 PPS decoding unit
253 SEI decoding unit
254 Slice header decoding unit
255 Slice data decoding unit
261, 262 Encoder

1. An image processing apparatus, comprising: a decoding unit configured to use inter-view prediction parameters used for inter-view prediction, and perform a decoding process on an encoded stream encoded in units having a hierarchy structure in the syntax of the encoded stream where the inter-view prediction parameters are collectively placed.

2. The image processing apparatus according to claim 1, wherein the inter-view prediction parameters are placed as extended data.

3. The image processing apparatus according to claim 2, wherein the inter-view prediction parameters are placed as the extended data of a slice.

4. The image processing apparatus according to claim 3, wherein the inter-view prediction parameters are placed at positions that are not copied in a slice having a dependent relationship.

5. The image processing apparatus according to claim 4, wherein the inter-view prediction parameters are placed in a different area from a copy destination to which copy is performed in a slice having a dependent relationship.

6. The image processing apparatus according to claim 1, wherein the inter-view prediction parameters are parameters related to inter-view prediction.

7. The image processing apparatus according to claim 6, wherein the inter-view prediction parameter is a parameter that manages a reference relationship in inter-view prediction.

8. The image processing apparatus according to claim 6, wherein the inter-view prediction parameter is a parameter used for weighted prediction in inter-view prediction.

9. The image processing apparatus according to claim 1, further comprising a receiving unit configured to receive the inter-view prediction parameters and the encoded stream,
wherein the decoding unit performs a decoding process on the inter-view prediction parameters received by the receiving unit, and performs a decoding process on the encoded stream received by the receiving unit, using the inter-view prediction parameters on which the decoding process has been performed.

10. An image processing method for an image processing apparatus, comprising: using inter-view prediction parameters used for inter-view prediction and performing a decoding process on an encoded stream encoded in units having a hierarchy structure in the syntax of the encoded stream where the inter-view prediction parameters are collectively placed.

11. An image processing apparatus, comprising:
an encoding unit configured to perform an encoding process on image data in units having a hierarchy structure and generating an encoded stream;
a placement unit configured to collectively place inter-view prediction parameters used for inter-view prediction in the syntax of the encoded stream generated by the encoding unit; and
a transmission unit configured to transmit the encoded stream generated by the encoding unit and the inter-view prediction parameters collectively placed by the placement unit.

12. The image processing apparatus according to claim 11, wherein the placement unit places the inter-view prediction parameters as extended data.

13. The image processing apparatus according to claim 12, wherein the placement unit places the inter-view prediction parameters as the extended data of a slice.

14. The image processing apparatus according to claim 13, wherein the placement unit places the inter-view prediction parameters at positions that are not copied in a slice having a dependent relationship.

15. The image processing apparatus according to claim 14, wherein the placement unit places the inter-view prediction parameters in a different area from a copy destination to which copy is performed in a slice having a dependent relationship.

16. The image processing apparatus according to claim 11, wherein the inter-view prediction parameters are parameters related to inter-view prediction.

17. The image processing apparatus according to claim 16, wherein the inter-view prediction parameter is a parameter that manages a reference relationship in inter-view prediction.

18. The image processing apparatus according to claim 16, wherein the inter-view prediction parameter is a parameter used for weighted prediction in inter-view prediction.

19. The image processing apparatus according to claim 11, wherein
the encoding unit performs an encoding process on the inter-view prediction parameters, and
the placement unit collectively places the inter-view prediction parameters on which the encoding process has been performed by the encoding unit.

20. An image processing method for an image processing apparatus, comprising:
performing an encoding process on image data in units having a hierarchy structure and generating an encoded stream:
collectively placing inter-view prediction parameters used for inter-view prediction in the syntax of the generated encoded stream; and
transmitting the generated encoded stream and the collectively placed inter-view prediction parameters.
